(19) United States
(12) Patent Application Publication
(10) Pub. No.: US 2023/0134522 A1
(43) Pub. Date: May 4, 2023

(54) GLASS ARTICLES HAVING TARGET COEFFICIENTS OF THERMAL EXPANSION AND INCREASED MODULUS AND METHODS FOR MAKING SAME

(71) Applicant: Corning Incorporated, Corning, NY (US)

(72) Inventors: Indrajit Dutta, Horseheads, NY (US); Heath Aaron Filkins, Corning, NY (US); Lisa Ann Lamberson, Painted Post, NY (US)

(21) Appl. No.: 17/978,369

(22) Filed: Nov. 1, 2022

Related U.S. Application Data
(60) Provisional application No. 63/275,666, filed on Nov. 4, 2021.

(51) Int. Cl. C03C 3/085

(52) U.S. Cl. CPC C03C 3/085; C03C 2203/10

(57) ABSTRACT

A glass article includes: from 60 mol % to 80 mol % SiO₂; from 5 mol % a to 25 mol % Al₂O₃; from 0.25 mol % to 10 mol % MgO; from 0.25 mol % to 10 mol % Na₂O; from 0 mol % to 2 mol % Li₂O; from 0 mol % to 9 mol % La₂O₃; and from 0 mol % to 9 mol % Y₂O₃. La₂O₃+Y₂O₃ is from 2 mol % to 9 mol %. (La₂O₃+Y₂O₃)/(R₂O+RO) is from 0.1 to 2, R₂O being the sum of Na₂O, Li₂O, and K₂O, and RO being the sum of MgO, CaO, SrO, and BaO.

This Application claims the benefit of priority to U.S. Provisional Patent Application Ser. No. 63/275,666 filed on Nov. 4, 2021, the content of which is relied upon and incorporated herein by reference in its entirety.

### FIELD

The present specification generally relates to glass articles and, in particular, to glass articles having target coefficients of thermal expansion and increased modulus.

### Technical Background

Glass articles are used in a variety of industries, including the semiconductor packaging industry. In the semiconductor packaging industry, chips are placed on carrier substrates (e.g., glass plates) for processing which may include thermo-mechanical and lithographic steps. However, processing techniques may vary among manufacturers, giving rise to different carrier requirements for different manufacturing techniques that, in turn, give rise to difficulties in manufacturing a single carrier substrate design that meets all the requirements for different manufacturers.

Accordingly, a need exists for alternative glass substrates for use in semiconductor manufacturing.

### SUMMARY

According to a first aspect Al, a glass article may comprise: greater than or equal to 60 mol % and less than or equal to 80 mol % SiO₂; greater than or equal to 5 mol % and less than or equal to 25 mol % Al₂O₃; greater than or equal to 0.25 mol % and less than or equal to 10 mol % MgO; greater than or equal to 0.25 mol % and less than or equal to 10 mol % Na₂O; greater than or equal to 0 mol % and less than or equal to 2 mol % Li₂O; greater than or equal to 0 mol % and less than or equal to 9 mol % La₂O₃; and greater than or equal to 0 mol % and less than or equal to 9 mol % T₂O₃, wherein La₂O₃+Y₂O₃ is greater than or equal to 2 mol % and less than or equal to 9 mol %, and wherein (La₂O₃+Y₂O₃)/(R₂O+RO) is greater than or equal to 0.1 and less than or equal to 2, R₂O being a sum of Na₂O, Li₂O, and K₂O expressed in mol %, and RO being a sum of MgO, CaO, SrO, and BaO expressed in mol %.

A second aspect A2 includes the glass article according to the first aspect A1 comprising greater than 0.5 mol % and less than or equal to 9 mol % Na₂O.

A third aspect A3 includes the glass article according to the second aspect A2 comprising greater than or equal to 0.75 mol % and less than or equal to 8 mol % Na₂O.

A fourth aspect A4 includes the article according to any one of the first through third aspects A1-A3, wherein La₂O₃+Y₂O₃ is greater than or equal to 3 mol % and less than or equal to 8 mol %.

A fifth aspect A5 includes the glass article according to any one of the first through fourth aspects A1-A4, wherein (La₂O₃+Y₂O₃+R₂O+RO)/Al₂O₃ is greater than or equal to 0.5 and less than or equal to 2.5.

A sixth aspect A6 includes the glass article according to the fifth aspect A5, wherein (La₂O₃+Y₂O₃+R₂O+RO)/Al₂O₃ is greater than or equal to 0.75 and less than or equal to 2.25.

A seventh aspect A7 includes the glass article according to any one of the first through sixth aspects A1-A6 comprising greater than or equal to 0.5 mol % and less than or equal to 9 mol % MgO.

An eighth aspect A8 includes the glass article according to any one of the first through seventh aspects A1-A7 comprising greater than or equal to 2 mol % and less than or equal to 9 mol % La₂O₃.

A ninth aspect A9 includes the glass article according to any one of the first through eighth aspects A1-A8 comprising greater than or equal to 2 mol % and less than or equal to 9 mol % Y₂O₃.

A tenth aspect A10 includes the glass article according to any one of the first through ninth aspects A1-A9 comprising greater than or equal to 0.5 mol % and less than or equal to 6 mol % B₂O₃.

An eleventh aspect All includes the glass article according to any one of the first through tenth aspects A1-A10 comprising greater than or equal to 0.1 mol % and less than or equal to 1.75 mol % Li₂O.

A twelfth aspect Al2 includes the glass article according to any one of the first through eleventh aspects A1-A11 comprising greater than or equal to 0.1 mol % and less than or equal to 5 mol % K₂O.

A thirteenth aspect A13 includes the glass article according to any one of the first through twelfth aspects A1-A12 comprising greater than or equal to 0.1 mol % and less than or equal to 10 mol % CaO.

A fourteenth aspect A14 includes the glass article according to any one of the first through thirteenth aspects A1-A13 comprising greater than or equal to 0.1 mol % and less than or equal to 5 mol % SrO.

A fifteenth aspect A15 includes the glass article according to any one of the first through fourteenth aspects A1-A14 comprising greater than or equal to 0.1 mol % and less than or equal to 3 mol % BaO.

A sixteenth aspect A16 includes the glass article according to any one of the first through fifteenth aspects A1-A15 comprising greater than 0 mol % and less than or equal to 1 mol % SnO₂.

A seventeenth aspect A17 includes the glass article according to any one of the first through sixteenth aspects A1-A16, wherein the glass article is substantially free or free of fluoride or fluoride containing components.

An eighteenth aspect Al 8 includes the glass article according to any one of the first through seventeenth aspects A1-A17, wherein a coefficient of thermal expansion of the glass article is greater than or equal to 45×10⁻⁷PC and less than or equal to 70×10⁻⁷/° C.

A nineteenth aspect A19 includes the glass article according to any one of the first through eighteenth aspects A1-A18, wherein a Young's modulus of the glass article is greater than or equal to 82 GPa.

A twentieth aspect A20 includes the glass article according to any one of the first through nineteenth aspects A1-A19, wherein a liquidus viscosity of the glass article is greater than or equal to 750 poise.

A twenty-first aspect A21 includes the glass article according to the twentieth aspect A20, wherein the liquidus viscosity of the glass article is greater than or equal to 1000 poise.

A twenty-second aspect A22 includes the glass article according to any one of the first through twenty-first aspects A1-A21, wherein a coefficient of thermal expansion of the glass article is greater than or equal to 45×10⁻⁷° C. and less than or equal to 70×10⁻⁷° C., a Young's modulus of the glass article is greater than or equal to 82 GPa, and a liquidus viscosity of the glass article is greater than or equal to 3000 poise.

A twenty-third aspect A23 includes the article according to any one of the first through twenty-second aspects A1-A22, wherein the glass article is configured as a carrier substrate for integrated circuit components.

According to the twenty-fourth aspect A24, a method may comprise: melting, in a melter, a first glass composition comprising a combination of glass constituent components in first relative proportions, the first relative proportions including a first constituent component at a first concentration; feeding into the melter a second glass composition comprising the combination of glass constituent components in second relative proportions, the second relative proportions including the first constituent component at a second concentration, the second concentration differing from the first concentration; forming at least three glass articles from a molten glass exiting the melter, the at least three glass articles comprising: a first glass article having a composition comprising the first glass composition; at least one intermediate glass article having a composition comprising the combination of glass constituent components in third relative proportions, the third relative proportions including the first constituent component at a third concentration, the third concentration differing from the first concentration and the second concentration; and a final glass article having a composition different from the composition of the first glass article and the composition of the at least one intermediate glass article; wherein the first glass composition and the second glass composition comprise: greater than or equal to 60 mol % and less than or equal to 80 mol % SiO₂; greater than or equal to 5 mol % and less than or equal to 25 mol % Al₂O₃; greater than or equal to 0.25 mol % and less than or equal to 10 mol % MgO; greater than or equal to 0.25 mol % and less than or equal to 10 mol % Na₂O; greater than or equal to 0 mol % and less than or equal to 2 mol % Li₂O; greater than or equal to 0 mol % and less than or equal to 9 mol % La₂O₃; and greater than or equal to 0 mol % and less than or equal to 9 mol % T₂O₃, wherein La₂O₃+Y₂O₃ is greater than or equal to 2 mol % and less than or equal to 9 mol %, and wherein (La₂O₃+Y₂O₃)/(R₂O+RO) is greater than or equal to 0.1 and less than or equal to 2, R₂O being the sum of Na₂O, Li₂O, and K₂O and RO being the sum of MgO, CaO, SrO, and BaO.

A twenty-fifth aspect A25 includes the method according to the twenty-fourth aspect A24, wherein the final glass article comprises the second glass composition.

A twenty-sixth aspect A26 includes the method according to the twenty-fourth aspect A24 or twenty-fifth aspect A25, wherein the first concentration is different from the second concentration by no more than 2 mol %.

A twenty-seventh aspect A27 includes the method according to any one of the twenty-fourth through twenty-sixth aspects A24-A26, wherein the first glass article and the final glass article each comprise a coefficient of thermal expansion greater than or equal to 45×10⁻⁷° C. and less than or equal to 70×10⁻⁷° C.

A twenty-eighth aspect A28 includes the method according to any one of the twenty-fourth through twenty-seventh aspects A24-A27, wherein the first glass article and the final glass article each comprise a Young's modulus greater than or equal to 82 GPa.

A twenty-ninth aspect A29 includes the method according to any one of the twenty-fourth through twenty-eighth aspects A24-A28, wherein the first glass composition and the second glass composition each comprise a liquidus viscosity greater than or equal to 750 poise.

A thirtieth aspect A30 includes the method according to any one of the twenty-fourth through twenty-ninth aspects A24-A29, wherein the first glass article and the final glass article each comprise a coefficient of thermal expansion greater than or equal to 45×10⁻⁷° C. and less than or equal to 70×10⁻⁷/° C., a Young's modulus greater than or equal to 82 GPa, and wherein the first glass composition and the second glass composition each comprise a liquidus viscosity greater than or equal to 3000 poise.

A thirty-first aspect A31 includes the method according to any one of the twenty-fourth through thirtieth aspects A24-A30, wherein each of the at least three glass articles is in the form of a boule.

A thirty-second aspect A32 includes the method according to any one of the twenty-fourth through thirtieth aspects A24-A30, wherein each of the at least three glass articles is in the form of a sheet.

A thirty-third aspect A33 includes the method according to any one of the twenty-fourth through thirty-second aspects A24-A32, wherein the feeding the second glass composition is simultaneous with the forming the at least three glass articles.

According to the thirty-fourth aspect A34, a glass composition may comprise: greater than or equal to 60 mol % and less than or equal to 80 mol % SiO₂; greater than or equal to 5 mol % and less than or equal to 25 mol % Al₂O₃; greater than or equal to 0.25 mol % and less than or equal to 10 mol % MgO; greater than or equal to 0.25 mol % and less than or equal to 10 mol % Na₂O; greater than or equal to 0 mol % and less than or equal to 2 mol % Li₂O; greater than or equal to 0 mol % and less than or equal to 9 mol % La₂O₃; and greater than or equal to 0 mol % and less than or equal to 9 mol % T₂O₃, wherein La₂O₃+Y₂O₃ is greater than or equal to 2 mol % and less than or equal to 9 mol %, and wherein (La₂O₃+Y₂O₃)/(R₂O+RO) is greater than or equal to 0.1 and less than or equal to 2, R₂O being a sum of Na₂O, Li₂O, and K₂O expressed in mol %, and RO being a sum of MgO, CaO, SrO, and BaO expressed in mol %.

A thirty-fifth aspect A35 includes the glass composition according to the thirty-fourth aspect A34 comprising greater than or equal to 0.75 mol % and less than or equal to 8 mol % Na₂O.

A thirty-sixth aspect A36 includes the glass composition according to the thirty-fourth aspect A34 or thirty-fifth aspect A35, wherein La₂O₃+Y₂O₃ is greater than or equal to 3 mol % and less than or equal to 8 mol %.

A thirty-seventh aspect A37 includes the glass composition according to any one of the thirty-fourth through thirty-sixth aspects A34-A36, wherein (La₂O₃+Y₂O₃+R₂O+RO)/Al₂O₃ is greater than or equal to 0.5 and less than or equal to 2.5.

A thirty-eighth aspect A38 includes the glass composition according to any one of the thirty-fourth through thirty-eighth aspects A34-A37 comprising greater than or equal to 0.5 mol % and less than or equal to 9 mol % MgO.

A thirty-ninth aspect A39 includes the glass composition according to any one of the thirty-fourth aspect A34 to thirty-eighth aspect A38 comprising greater than or equal to 2 mol % and less than or equal to 9 mol % La₂O₃.

A fortieth aspect A40 includes the glass composition according to any one of the thirty-fourth through thirty-ninth aspects A34-A39 comprising greater than or equal to 2 mol % and less than or equal to 9 mol % Y₂O₃.

A forty-first aspect A41 includes the glass composition according to any one of the thirty-fourth aspect through fortieth aspects A34-A40 comprising greater than or equal to 0.5 mol % and less than or equal to 6 mol % B₂O₃.

A forty-second aspect A42 includes the glass composition according to any one of the thirty-fourth through forty-first aspects A34-A41 comprising greater than or equal to 0.1 mol % and less than or equal to 1.75 mol % Li₂O.

A forty-third aspect A43 includes the glass composition according to any one of the thirty-fourth through forty-second aspects A34-A42 comprising greater than or equal to 0.1 mol % and less than or equal to 5 mol % K₂O.

A forty-fourth aspect A44 includes the glass composition according to any one of the thirty-fourth through forty-third aspects A34-A43 comprising greater than or equal to 0.1 mol % and less than or equal to 10 mol % CaO.

A forty-fifth aspect A45 includes the glass composition according to any one of the thirty-fourth through forty-fourth aspects A34-A44 comprising greater than or equal to 0.1 mol % and less than or equal to 5 mol % SrO.

A forty-sixth aspect A46 includes the glass composition according to any one of the thirty-fourth through forty-fifth aspects A34-A45 comprising greater than or equal to 0.1 mol % and less than or equal to 3 mol % BaO.

A forty-seventh aspect A47 includes the composition according to any one of the thirty-fourth through forty-sixth aspects A34-A46, wherein a liquidus viscosity of the glass composition is greater than or equal to 750 poise.

Additional features and advantages of the glass articles described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts one example glass manufacturing apparatus for forming glass articles in accordance with one or more embodiments shown and described herein;

FIG. 2 is a plot of measured CTE (Y-axis; values x 10⁻⁷/° C.) as a function of total modifier cation field strength (X-axis) in accordance with one or more embodiments shown and described herein;

FIG. 3 is a plot of modeled CTE (Y-axis; values x 10⁻⁷/° C.) as a function of total modifier cation field strength (X-axis) in accordance with one or more embodiments shown and described herein;

FIG. 4 is a plot of Young's modulus (Y-axis; in GPa) as a function of La₂O₃ concentration (X-axis; in mol %) for example glass compositions according to one or more embodiments shown and described herein;

FIG. 5 is a plot of liquidus viscosity (Y-axis; in Poise) as a function of La₂O₃ concentration (X-axis; in mol %) for example glass compositions according to one or more embodiments shown and described herein; and

FIG. 6 is a plot of Young's modulus (Y-axis; in GPa) as a function of CTE (X-axis; in X 10⁻⁷/° C.) for example glass compositions according to one or more embodiments shown and described herein.

### DETAILED DESCRIPTION

Reference will now be made in detail to various embodiments of glass articles having target coefficients of thermal expansion and increased modulus. According to embodiments, a glass article includes: greater than or equal to 60 mol % and less than or equal to 80 mol % SiO₂; greater than or equal to 5 mol % and less than or equal to 25 mol % Al₂O₃; greater than or equal to 0.25 mol % and less than or equal to 10 mol % MgO; greater than or equal to 0.25 mol % and less than or equal to 10 mol % Na₂O; greater than or equal to 0 mol % and less than or equal to 2 mol % Li₂O; greater than or equal to 0 mol % and less than or equal to 9 mol % La₂O₃; and greater than or equal to 0 mol % and less than or equal to 9 mol % Y₂O₃. La₂O₃+Y₂O₃ is greater than or equal to 2 mol % and less than or equal to 9 mol %. (La₂O₃+Y₂O₃)/(R₂O+RO) is greater than or equal to 0.1 and less than or equal to 2, R₂O being the sum of Na₂O, Li₂O, and K₂O, and RO being the sum of MgO, CaO, SrO, and BaO. Various embodiments of glass articles and methods of making the same will be described herein with specific reference to the appended drawings.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

The term “and/or” shall also be interpreted to be inclusive (e.g., “x and/or y” means one or both x or y). In situations where “and/or” or “or” are used as a conjunction for a group of three or more items, the group should be interpreted to include one item alone, all the items together, or any combination or number of the items. Moreover, terms used in the specification and claims such as have, having, include, and including should be construed to be synonymous with the terms comprise and comprising.

As used herein, the term “R20” refers to the sum of Na₂O, Li₂O, and K₂O, and the term “RO” refers to the sum of MgO, CaO, SrO, and BaO in the batch composition.

Unless otherwise specified, all glass compositions are expressed in terms of as-batched mole percent (mol %) and references to “composition” or “glass composition” refer to composition expressed in terms of mol % in the batch composition (that is, in the as-batched, pre-melt state of the components). The term “concentration”, when used in reference to a component means mol % of the component in the batch composition. As will be understood by those having ordinary skill in the art, various melt constituents (e.g., fluorine, alkali metals, boron, etc.) may be subject to different levels of volatilization (e.g., as a function of vapor pressure, melt time and/or melt temperature) during melting of the constituents. As such, the term “about,” in relation to such constituents, is intended to encompass values within about 0.2 mol % when measuring final articles as compared to the as-batched compositions provided herein. With the forgoing in mind, substantial compositional equivalence between final articles and as-batched compositions is expected.

Oxides and other constituents of the batch composition of the glass are referred to as “constituent components” or “components”. Oxide components of the batch composition are referred to as “batch oxides”.

Whenever a component is included as a term in a mathematical expression or formula, it is understood that the component refers to the amount of the component in the glass composition in units of mol %. A mathematical expression or formula is any expression or formula that includes a mathematical operator such as “+” (addition), “−” (subtraction), “*” (multiplication), “/” (division or ratio).

Expressions combining components with the mathematical symbol “+” refer to sums of the components in the glass composition expressed in mol %. For example, the expression “La₂O₃+Y₂O₃” means the sum of the concentrations of the components La₂O₃ and T₂O₃, each expressed in mol %, in the glass composition. Expressions combining components with the mathematical symbol “/” refer to ratios obtained by division of the components (or sums of components) in the glass composition expressed in mol %. For example, the expression “(La₂O₃+Y₂O₃)/(R₂O+RO)” means the ratio obtained from the division of (La₂O₃+Y₂O₃) by (R₂O+RO).

The term “substantially free,” when used to describe the concentration and/or absence of a particular constituent component in a glass composition and the resultant glass article, means that the constituent component is not intentionally added to the glass composition and the resultant glass article. However, the glass composition and the resultant glass article may contain traces of the constituent component as a contaminant or tramp in amounts of less than 0.1 mol %.

The terms “0 mol %” and “free,” when used to describe the concentration and/or absence of a particular constituent component in a glass composition and the resultant glass article means that the constituent component is not present in glass composition and the resultant glass article.

The term “glass article” or “resultant glass article” refers to glass formed by melting and subsequently cooling a glass composition. Glass articles include, without limitation, glass substrates, which may also be referred to as carrier substrates or resultant glass substrates.

The term “coefficient of thermal expansion” and “CTE,” as described herein, refers to an average CTE measured in accordance with ASTM E228-85 over the temperature range of 25° C. to 250° C. and is expressed in terms of “x 10⁻⁷/° C.”

The Young's modulus of the glass article, as described herein, is provided in units of gigapascals (GPa) and is measured in accordance with ASTM C623.

The term “liquidus viscosity,” as used herein, refers to the viscosity of the glass composition at the onset of devitrification (i.e., at the liquidus temperature as determined with the gradient furnace method according to ASTM C829-81).

In the semiconductor packaging industry, different manufacturers have overarching carrier substrate requirements (i.e., size, shape, etc.) that are somewhat uniform. However, the property specifications of carrier substrates (i.e., coefficient of thermal expansion, Young's modulus, and the like) may differ from manufacturer to manufacturer or even from facility to facility. For example, the thermal profile of a semiconductor packaging process may be unique to a specific manufacturer, which in turn, gives rise to a need for carrier substrates having thermal characteristics tailored to the specific thermal profile, such as the coefficient of thermal expansion (CTE) or the like. In addition to particular CTE requirements, the carrier substrates may also need to have certain other properties, such as Young's modulus, liquidus viscosity, surface quality, and edge strength requirements, to be considered suitable for use in conjunction with particular semiconductor packaging operations. The wide array of property specifications for carrier substrates presents a unique challenge to manufacturers of carrier substrates seeking to economically and efficiently mass produce carrier substrates compatible for use with different packaging operations.

For example, semiconductor fabrication labs may need to perform a wide array of post-fabrication processing of the semiconductor. This processing typically includes placing the semiconductor on the carrier substrate and then performing thermo-mechanical as well as lithographic steps. The steps may be used to add metal connects, epoxy molding compounds, soldering, and the like. Historically, the semiconductor packaging industry used polymer material as the carrier substrate. The polymer material was sufficient for low-end chip packaging, but has proven unsatisfactory for manufacturing high-end products due to the inherent structural instability of polymers at the processing temperatures required for more complex chip packaging.

A recent trend in this industry is to use glass wafers (200 mm/300 mm diameter) or panels (500 mm×500 mm) as carrier substrates instead of polymer materials. Glass substrates offer greater thermal stability than polymer materials and permit packaging of semiconductors at higher process temperatures. Depending on the manufacturer and the particular steps involved in the post-fabrication semiconductor packaging process, the carrier substrate may experience variable amounts of stress and warpage throughout the post-fabrication process, and therefore must have custom CTE requirements, for example, to maintain consistent dimensions throughout the post-fabrication process.

To simplify the process of obtaining glasses meeting these custom CTE requirements, a library of glass articles may be produced that have a composition within a certain range (i.e., the compositions are similar), but physical properties which differ among each article in the library. This range of properties for a similar composition allows an end user to select and test a particular glass article for a specific property to determine the viability of using the glass article as a carrier substrate for a particular application without the need to specifically create an entire batch of glass when only a few exemplary glasses may be needed to validate the process. Of course, a range of other properties and applications, beyond CTE in semiconductor fabrication, are contemplated and possible.

Disclosed herein are glass compositions and methods of forming glass substrates therefrom that are compatible with the processes employed in semiconductor packaging by various manufacturers, while allowing the properties of the glass substrates, including the CTE and Young's modulus, to be tuned to meet the specifications of individual manufacturers. In particular, the sum of concentrations of La₂O₃ and Y₂O₃ (i.e., La₂O₃ (mol %)+Y₂O₃ (mol %)) in the glass composition and the concentration of alkali oxides (i.e., Na₂O, Li₂O, and K₂O) and alkaline earth oxides (i.e., MgO, CaO, SrO, and BaO) of a base glass composition may be modified and balanced to achieve a glass composition and a resultant glass substrate with an increased Young's modulus greater than or equal to 82 GPa and a target coefficient of expansion CTE_{T} greater than or equal to 45×10⁻⁷° C. and less than or equal to 70×10⁻⁷° C.

Method of Forming Glass Article

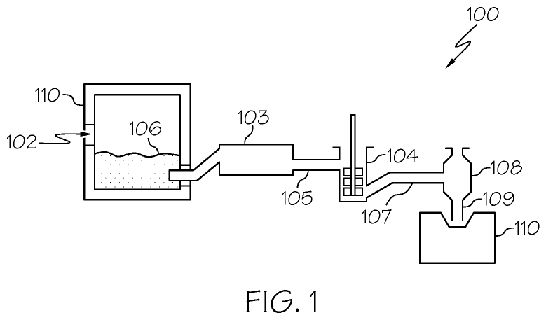

Referring now to FIG. 1, an example glass manufacturing apparatus 100 for forming a library of glass articles from molten glass is schematically depicted according to one or more embodiments described herein. The glass manufacturing apparatus 100 includes a melting vessel 101, a fining vessel 103, a mixing vessel 104, a delivery vessel 108, and a forming vessel 110. Glass batch materials are introduced into the melting vessel 101 as indicated by arrow 102. The batch materials, including batch oxides in proportions corresponding to the batch composition, are melted to form molten glass 106. The melting vessel 101 may include heating elements (not shown) for melting the batch materials. The fining vessel 103 has a high temperature processing area that receives the molten glass 106 from the melting vessel 101 and in which bubbles are removed from the molten glass 106. The fining vessel 103 is fluidly coupled to the mixing vessel 104 by a connecting tube 105. That is, molten glass flowing from the fining vessel 103 to the mixing vessel 104 flows through the connecting tube 105. The mixing vessel 104 is, in turn, fluidly coupled to the delivery vessel 108 by a connecting tube 107 such that molten glass flowing from the mixing vessel 104 to the delivery vessel 108 flows through the connecting tube 107.

The delivery vessel 108 supplies the molten glass 106 through a downcomer 109 into the forming vessel 110. The delivery vessel 108 may include heating elements (not shown) for heating and/or maintaining the glass in a molten state and/or preventing devitrification. In some embodiments, the delivery vessel 108 may cool and condition the molten glass in order to increase the viscosity of the glass prior to providing the glass to the forming vessel 110. The forming vessel 110 may be, for example, a fusion draw device, a slot draw device or a mold. The form of the resulting glass article will vary depending on the particular forming vessel 110 employed. In some embodiments, the glass article resulting from the forming vessel 110 may be in the form of a glass plate. However, in some embodiments, the glass article resulting from the forming vessel 110 may be in the form of a glass boule, which may then be formed into a glass plate (e.g. by sawing, grinding, and/or polishing). If the composition in the melting vessel 101 is varied, the resulting glass articles will exhibit different properties due to slightly different composition of each.

One convenient application for the methods described herein is to manufacture a library of glass articles having a range of target CTE_{T} (e.g., greater than or equal to 45×10⁻⁷/° C. and less than or equal to 70×10⁻⁷° C.) that may be achieved by making changes to a base glass composition introduced to glass manufacturing apparatus 100. In embodiments, the method includes replacing an amount of a first alkaline earth component (e.g., MgO, CaO, SrO, and BaO) or a first alkali component (e.g., Na₂O, Li₂O, and K₂O) having a first cation field strength in the base glass composition with an amount of a second alkaline earth component or a second alkali component having a second cation field strength that is different from the first cation field strength. Without being bound by theory, it is believed that the CTE of an oxide glass depends on the strength of the bonds between the cations and the oxygen network. Accordingly, adjusting the overall cation field strength of the glass can be an effective driver to change the CTE of a resultant glass article.

In embodiments, the CTE of the glass article may be selectively modified, or “tuned,” by adjusting the amounts of various batch oxides added to the melting vessel 101, replacing one or more batch oxides with a different batch oxide. As used herein, the term “replaced” means that a batch oxide may be reduced in amount or even eliminated from the glass composition and a different batch oxide may be added to the glass composition or increased in amount. In embodiments in which the glass manufacturing process is a continuous method, replacement of one batch oxide with another batch oxide may include adding amounts of other batch oxides to the melting vessel 101 and not adding additional amounts of the batch oxide being replaced such that, over time, the batch oxide being replaced is reduced or eliminated from the molten glass composition in the melting vessel 101. Accordingly, the one or more batch oxides to be replaced may be replaced in the glass batch composition with other batch oxides introduced to the melting vessel 101 and these other batch oxides ultimately may become components of the molten glass 106 to provide a glass article with a different composition and different properties (e.g. CTE, modulus etc.). Continuous tuning of properties is achievable through continuous modification of the batch composition introduced to melting vessel 101.

In embodiments, an amount of one or more batch oxides (e.g., a first alkaline earth component or a first alkali component having a first cation field strength) in the base glass composition may be replaced with an amount of a different batch oxide (e.g., a second alkaline earth component or a second alkali component having a second cation field strength that is different from the first cation field strength) to achieve a target coefficient of thermal expansion CTE_{T} (e.g., greater than or equal to 45×10⁻⁷PC and less than or equal to 70×10⁻⁷/° C.) by modifying the overall cation field strength of the glass article formed from the glass composition. That is, it has been determined that the coefficient of thermal expansion of the glass article is related to the overall cation field strength of the batch oxides included in the batch composition used to form the glass article. For example, if the target CTE_{T} is greater than the coefficient of thermal expansion of the base glass CTE_{B}, the overall cation field strength for the glass composition should be decreased to achieve the target CTET, whereas if the target CTE_{T} is less than the base glass CTE_{B}, the overall cation field strength for the glass composition should be increased to achieve the target CTET. As used herein, the term “base glass composition” refer to an initial glass composition introduced to melting vessel 101 prior to the modification of the glass composition used to vary cation field strength. The glass composition resulting from modification of the base glass composition is referred to herein as the “modified glass composition.” The terms “base glass” and “modified glass” refer to the glass article formed from the base glass composition and modified glass composition, respectively. The base glass composition and/or modified glass composition may also be referred to as a “first glass composition,” as well as a “second glass composition” or a “third glass composition.”

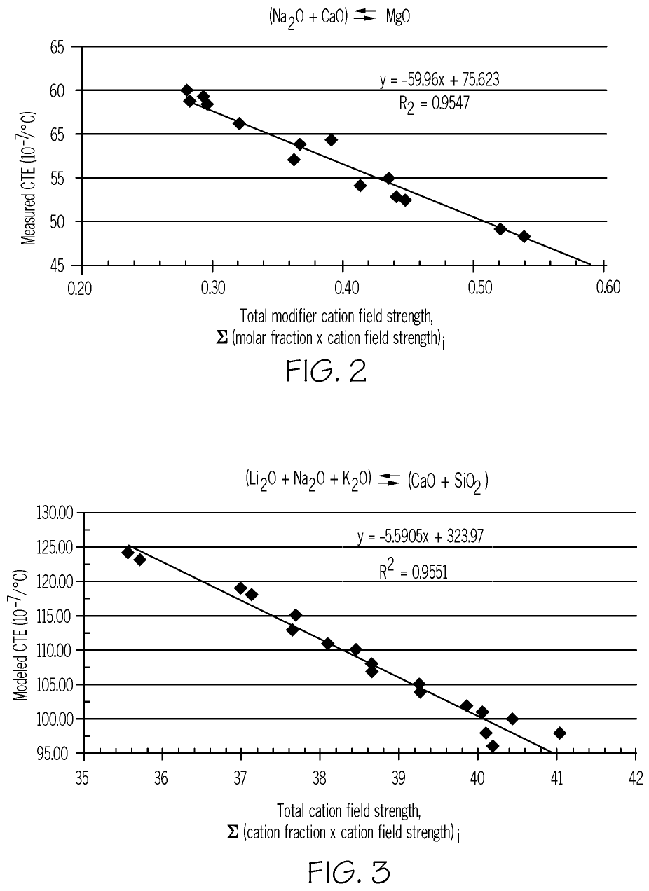

The cation field strength of a cation may be represented as Z/r², where Z is the charge (unitless) of the cation and r is the radius (in Angstrom) of the cation. The overall cation field strength of a glass composition is calculated by multiplying the cation field strength of a cation by the mole fraction of the oxide of the cation in the glass composition and summing over all cations included in the calculation for the glass composition. For purposes of FIG. 2 of the present application, only cations of the following oxides are considered in the overall cation field strength calculation of each glass composition disclosed herein: Na₂O, CaO, MgO, K₂O, and Li₂O. For purposes of FIG. 3 of the present application, only cations of the following oxides are considered in the overall cation field strength calculation of each glass composition disclosed herein: Na₂O, CaO, MgO, K₂O, Li₂O, and SiO₂. The number of cations per oxide molecule is then multiplied by the mole fraction of the oxide and the field strength for each cation to obtain the contribution of each oxide to the overall cation field strength of the glass composition. The overall cation field strength is the sum of the contribution of each oxide present in the glass composition. Table 1 provides cation field strength values for various cations that may be included in the batch oxides. The cation field strength of Si' is 1.52 A⁻².

TABLE 1
Cation Field Strength in Silicate Glasses*

| Cation | Field strength (Å⁻²) |
|---|---|
| Alkali | |
| Li⁺¹ | 0.26 |
| Na⁺¹ | 0.18 |
| K⁺¹ | 0.12 |
| Alkaline Earth | |
| Mg⁺² | 0.46 |
| Ca⁺² | 0.36 |

*G.E. Brown, F Farges, and G. Calas, Rev. Mineral., 32, 317-410, 1995.

FIGS. 2 and 3 are exemplary plots of measured and modeled CTE (Y-axis; values x 10⁻⁷ /° C.), respectively, as a function of overall cation field strength (X-axis). As may be seen from the R² value obtained from a least squares fit of the data of FIGS. 2 and 3, the CTE is highly correlated with the overall cation field strength. In this example, when MgO is replaced by Na₂O and CaO in the glass composition, the CTE increases from about 45×10⁻⁷/° C. to about 70×10⁻⁷/° C., with increasing overall cation field strength correlating with decreasing CTE. Similarly, when CaO and SiO₂ are replaced by Li₂O+Na₂O+K₂O in the glass composition, the CTE increases from about 90×10⁻⁷/° C. to about 130×10⁻⁷/° C., with increasing overall cation field strength correlating with decreasing CTE.

In order to achieve the desired overall cation field strength (and thus the target CTET) for the glass article, an amount of a first alkaline earth component in the glass composition may be replaced with an amount of a second alkaline earth component, an amount of a first alkali component in the glass composition may be replaced with an amount of a second alkali component, an amount of an alkaline earth component in the glass composition may be replaced with an amount of an alkali component, or an amount of an alkali component in the glass composition can be replaced with an amount of an alkaline earth component. In embodiments, an amount of any component may be replaced by an amount of any other component.

For example, if the target CTE_{T} is greater than the base glass CTE_{B}, in embodiments, an amount of a first alkaline earth component in the glass composition of the base glass may be replaced with an amount of an alkali component or with an amount of a second alkaline earth component having a cation field strength that is less than the cation field strength of the first alkaline earth component. In embodiments, an amount of a first alkali component in the glass composition of the base glass may be replaced with an amount of a second alkali component having a cation field strength that is less than the cation field strength of the first alkali component. For example, in embodiments, an amount of MgO in the glass composition of the base glass is replaced with an amount of Na₂O to produce a modified glass with a target CTE_{T} that is greater than the base glass CTE_{B}.

As another example, if the target CTE_{T} is less than the base glass CTE_{B}, in embodiments, an amount of a first alkali component in the glass composition of the base glass may be replaced with an amount of an alkaline earth component or with an amount of a second alkali component having a cation field strength that is greater than the cation field strength of the first alkali component. In embodiments, an amount of a first alkaline earth component in the glass composition of the base glass may be replaced with an amount of a second alkaline earth component having a cation field strength that is greater than the cation field strength of the first alkaline earth component. For example, in embodiments, an amount of Na₂O in the glass composition of the base glass is replaced with an amount of MgO to produce a modified glass with a target CTE_{T} that is less than the base glass CTE_{B}.

The base glass composition or modified glass composition may be any one of a number of suitable glass compositions. For example, the base glass composition or modified glass composition may be an alkali boroaluminosilicate glass composition, an alkaline earth boroaluminosilicate glass composition, a zinc boroaluminosilicate glass composition, or the like. The base glass composition may be selected based on its CTE at a particular temperature or over a range of temperatures (e.g., 0° C. to 400° C., 0° C. to 300° C., 0° C. to 260° C., 20° C. to 300° C., or 20° C. to 260° C.), its density, its Young's modulus, its liquidus viscosity, or other properties that may be desired for processing or use of the glass article.

Methods described herein facilitate forming carrier glass substrates having compositions that are compatible with the thermal packaging processes employed by various manufacturers, while allowing the properties of the carrier substrates, including the CTE and Young's modulus, to be tuned to meet the specifications of individual manufacturers. Specifically, embodiments described herein relate to a method of producing a glass article such as a glass substrate. In embodiments, the method includes melting a first glass composition in a melter, the first glass composition comprising a combination of glass constituent components. A second glass composition may then be fed into the melter. This second glass composition may include the same combination of glass constituent components, but at least one glass constituent component has a concentration that is different from the concentration of the same constituent component in the first glass composition (sometimes referred to as the “varied component” or “varied constituent component”). In embodiments, at least three glass articles may be drawn from the melter while maintaining the contents of the melter in a molten state. The at least three glass articles may include: (1) a first glass article that is formed from the first glass composition; (2) at least one intermediate glass article that is composed of neither the first glass composition nor the second glass composition and which may be drawn either simultaneously with the feeding of the second glass composition or at some different time; (3) and a final glass article that is derived from a glass composition that is different from the first glass composition and may be the same as or different from the second glass composition. The concentration of the at least one component in the at least one intermediate glass article may be between the concentration of the at least one component in the first glass composition and the concentration of the at least one component in the second glass composition. The first glass article may have a first set of values for a set of properties. The final glass article may have a second set of values for the same set of properties, the second set of values being different from the first set of values. The at least one intermediate glass article may have an intermediate set of values for the set of properties that is between the first set of values and the second set of values.

Of course, more than a second glass composition could be added to the melter. For instance, the method may further include feeding a third glass composition into the melter. This third glass composition may include the same combination of glass constituent components, but just as with the second glass composition described above, at least one glass constituent component may have a concentration that differs from that of both the first glass composition and the second glass composition. Then, the method may further include drawing at least a first additional glass article and a final additional glass article from the melter while maintaining the contents of the melter in a molten state. The first additional glass article may have a first additional set of values for the same set of properties discussed above, and the final additional glass article may have a final additional set of values for the same set of properties.

In embodiments, the concentration of the varied component in the first glass composition may be different from that in the second glass composition by no more than 2 mol %. For instance, the concentration of the varied component in the first glass composition may be different from that in the second glass composition by no more than 1.9 mol %, 1.8 mol %, 1.7 mol %, 1.6 mol %, 1.5 mol %, 1.4 mol %, 1.3 mol %, 1.2 mol %, 1.1 mol %, 1 mol %, 0.9 mol %, 0.8 mol %, 0.7 mol %, 0.6 mol %, 0.5 mol %, 0.4 mol %, 0.3 mol %, 0.2 mol %, 0.1 mol %, or any fractional part thereof. Further, all of the components of the first glass composition may have different concentrations in the second glass composition or all the components except one may retain the concentration present in the first glass composition. Thus, the concentration of one component, two components, three components, and so on, up to and including the concentration of all the components of the first glass composition, may be different in the second glass composition.

The at least one component, the concentration of which may differ between the first and second glass compositions, i.e. the varied component, may be any of the constituent components.

As noted above, the first glass article may have a first set of values for a set of properties, the final glass article may have a second set of values, and the at least one intermediate glass article may have an intermediate set of values. Such properties may include, but are not limited to, CTE, Young's modulus, density, liqudus viscosity, surface quality, refractive index, resistivity, and edge strength. In embodiments, the CTE of the first glass article may be equal to or within ±7.5×10⁻⁷/° C. from the CTE of the final glass article. In embodiments, where a third glass composition is added to the melter, the CTE of the first glass article may be equal to or within ±15×10⁻⁷/° C. different from the CTE of the final additional glass article.

Certain properties may remain substantially unchanged throughout the method, including the draws of all glass articles. Similar effects may be observed when more than a second glass composition, e.g., a third glass composition, is added to the melter.

In embodiments, the value of only one property of a set of properties differs between the first, final, and intermediate glass articles. In embodiments, all such values differ. In embodiments, the values of any number of properties of a set of properties, from a single property to all properties, may differ between the first, final, and intermediate glass articles.

In embodiments, the values of two or more properties may not differ to the same extent between the first, final, and intermediate glass articles. For instance, the value of one property may differ to a much larger degree than the value of another property. In embodiments, for example, the difference between the CTE of the at least one intermediate glass article and the CTE of the first glass article, as a percentage of the CTE of the first glass article, may be greater than the difference between the Young's modulus of the at least one intermediate glass article and the Young's modulus of the first glass article, as a percentage of the Young's modulus of the first glass article. Similar effects may be observed when more than a second glass composition, e.g., a third glass composition, is added to the melter.

The shape of the glass articles produced is not particularly limited. Exemplary shapes include, but are not limited to, a glass boule or a sheet. Any number of glass articles with different and unique glass compositions may be drawn from the melter. For example, hundreds, or even thousands, of glass articles may be drawn. A smaller number may also be drawn. For example, at least 5 glass articles may be drawn, i.e., the first glass article, the final glass article, and 3 intermediate glass articles. In the same or different embodiments, at least 10 glass articles may be drawn, i.e., at least 8 intermediate glass articles. Similarly, in the same or different embodiments, at least 20 glass articles may be drawn, i.e., at least 18 intermediate glass articles. Similarly, in the same or different embodiments, at least 30 glass articles may be drawn, i.e., at least 28 intermediate glass articles. Similar numbers of glass articles may be drawn when more than a second glass composition, e.g., a third glass composition, is added to the melter, but of course, even more glass articles could be drawn under such conditions. Due to the change in the concentration of the at least one component between the first and second glass compositions, the composition of the glass article drawn changes slowly over time from one derived from the first glass composition to that derived from the second glass composition. Each intermediate article may be drawn at a different time. So, each intermediate article has a different concentration of the at least one glass constituent component that is between the concentration of the at least one glass constituent component in the first glass composition and the concentration of the at least one glass constituent component in the second glass composition. If two intermediate articles are drawn at about the same time, the difference in composition may be slight. As more time passes, the difference in composition may become more pronounced.

Glass Compositions and Glass Articles

The glass compositions and glass articles described herein may be described as alkali/alkaline earth aluminosilicate glass compositions and comprise SiO₂, Al₂O₃, MgO, and/or Na₂O. In addition to SiO₂, Al₂O₃, MgO, and Na₂O, the glass compositions and the glass articles described herein may include other alkali oxides, such as Li₂O. Furthermore, the glass compositions described herein include La₂O₃ and/or Y₂O₃ to achieve a desired Young's modulus (e.g., greater than or equal to 82 MPa). Increasing the concentration of La₂O₃ and/or Y₂O₃ increases the Young's modulus of the resultant glass article (e.g. glass substrate). The Young's modulus increases with the increasing ratio of La₂O₃+Y₂O₃ to R₂O +RO (i.e., (La₂O₃+Y₂O₃)/(R₂O+RO)). However, as La₂O₃ and/or Y₂O₃ are added to increase the Young's modulus, CTE decreases. Accordingly, the alkali oxides R₂O (i.e., Na₂O, Li₂O, and K₂O) and/or alkaline earth oxides RO ((i.e., MgO, CaO, SrO, and BaO) present in the glass compositions and resultant glass articles may be modified as described hereinabove to decrease the overall cation field strength, thereby increasing the CTE that may have been reduced by the presence of La₂O₃+Y₂O₃.

SiO₂ is the primary glass former in the glass compositions described herein and may function to stabilize the network structure of the glass articles. The concentration of SiO₂ in the glass compositions and resultant glass articles should be sufficiently high (e.g., greater than or equal to 60 mol %) to obtain a glass article having suitable impact resistance. The amount of SiO₂ may be limited (e.g., to less than or equal to 80 mol %) to control the melting point and viscosity of the glass composition, as the melting point and viscosity of pure SiO₂ or high SiO₂ glasses are undesirably high for preferred low-cost glass forming techniques. Thus, limiting the concentration of SiO₂ may aid in improving the meltability and the formability of the glass composition used to form the glass article.

In embodiments, the glass composition used to form glass articles described herein may comprise greater than or equal to 60 mol % and less than or equal to 80 mol % SiO₂. In embodiments, the concentration of SiO₂ in the glass composition may be greater than or equal to 60 mol %, greater than or equal to 62 mol %, or even greater than or equal to 64 mol %. In embodiments, the concentration of SiO₂ in the glass composition may be less than or equal to 80 mol %, less than or equal to 77 mol %, less than or equal to 75 mol %, less than or equal to 73 mol %, or even less than or equal to 70 mol %. In embodiments, the concentration of SiO₂ in the glass composition may be greater than or equal to 60 mol % and less than or equal to 80 mol %, greater than or equal to 60 mol % and less than or equal to 77 mol %, greater than or equal to 60 mol % and less than or equal to 75 mol %, greater than or equal to 60 mol % and less than or equal to 73 mol %, greater than or equal to 60 mol % and less than or equal to 70 mol %, greater than or equal to 62 mol % and less than or equal to 80 mol %, greater than or equal to 62 mol % and less than or equal to 77 mol %, greater than or equal to 62 mol % and less than or equal to 75 mol %, greater than or equal to 62 mol % and less than or equal to 73 mol %, greater than or equal to 62 mol % and less than or equal to 70 mol %, greater than or equal to 64 mol % and less than or equal to 80 mol %, greater than or equal to 64 mol % and less than or equal to 77 mol %, greater than or equal to 64 mol % and less than or equal to 75 mol %, greater than or equal to 64 mol % and less than or equal to 73 mol %, or even greater than or equal to 64 mol % and less than or equal to 70 mol %, or any and all sub-ranges formed from any of these endpoints.

Al₂O₃, in conjunction with alkali oxides present in the glass composition, such as Na₂O or the like, improves the susceptibility of the glass article to ion exchange strengthening. Moreover, increased amounts of Al₂O₃ may also increase the softening point of the glass article, thereby reducing the formability of the glass article. In embodiments, the glass composition used to form glass articles disclosed herein may comprise greater than or equal to 5 mol % and less than or equal to 25 mol % Al₂O₃. In embodiments, the concentration of Al₂O₃ in the glass composition may be greater than or equal to 5 mol %, greater than or equal to 7 mol %, greater than or equal to 9 mol %, or even greater than or equal to 11 mol %. In embodiments, the concentration of Al₂O₃ in the glass composition may be less than or equal to 25 mol %, less than or equal to 23 mol %, less than or equal to 20 mol %, or even less than or equal to 17 mol %. In embodiments, the concentration of Al₂O₃ in the glass composition may be greater than or equal to 5 mol % and less than or equal to 25 mol %, greater than or equal to 5 mol % and less than or equal to 23 mol %, greater than or equal to 5 mol % and less than or equal to 20 mol %, greater than or equal to 5 mol % and less than or equal to 17 mol %, greater than or equal to 7 mol % and less than or equal to 25 mol %, greater than or equal to 7 mol % and less than or equal to 23 mol %, greater than or equal to 7 mol % and less than or equal to 20 mol %, greater than or equal to 7 mol % and less than or equal to 17 mol %, greater than or equal to 9 mol % and less than or equal to 25 mol %, greater than or equal to 9 mol % and less than or equal to 23 mol %, greater than or equal to 9 mol % and less than or equal to 20 mol %, greater than or equal to 9 mol % and less than or equal to 17 mol %, greater than or equal to 11 mol % and less than or equal to 25 mol %, greater than or equal to 11 mol % and less than or equal to 23 mol %, greater than or equal to 11 mol % and less than or equal to 20 mol %, or even greater than or equal to 11 mol % and less than or equal to 17 mol %, or any and all sub-ranges formed from any of these endpoints.

MgO improves the meltability of the glass compositions and increases the chemical durability of the glass composition, in addition to influencing the CTE. In embodiments, the glass composition used to form glass articles described herein may comprise greater than or equal to 0.25 mol % and less than or equal to 10 mol % MgO. In embodiments, the glass composition may comprise greater than or equal to 0.5 mol % and less than or equal to 9 mol % MgO. In embodiments, the concentration of MgO in the glass composition may be greater than or equal to 0.25 mol %, greater than or equal to 0.5 mol %, greater than or equal to 1 mol %, or even greater than or equal to 2 mol %. In embodiments, the concentration of MgO in the glass composition may be less than or equal to 10 mol %, less than or equal to 9 mol %, less than or equal to 8 mol %, less than or equal to 7 mol %, or even less than or equal to 6 mol %. In embodiments, the concentration of MgO in the glass composition may be greater than or equal to 0.25 mol % and less than or equal to 10 mol %, greater than or equal to 0.25 mol % and less than or equal to 9 mol %, greater than or equal to 0.25 mol % and less than or equal to 8 mol %, greater than or equal to 0.25 mol % and less than or equal to 7 mol %, greater than or equal to 0.25 mol % and less than or equal to 6 mol %, greater than or equal to 0.5 mol % and less than or equal to 10 mol %, greater than or equal to 0.5 mol % and less than or equal to 9 mol %, greater than or equal to 0.5 mol % and less than or equal to 8 mol %, greater than or equal to 0.5 mol % and less than or equal to 7 mol %, greater than or equal to 0.5 mol % and less than or equal to 6 mol %, greater than or equal to 1 mol % and less than or equal to 10 mol %, greater than or equal to 1 mol % and less than or equal to 9 mol %, greater than or equal to 1 mol % and less than or equal to 8 mol %, greater than or equal to 1 mol % and less than or equal to 7 mol %, greater than or equal to 1 mol % and less than or equal to 6 mol %, greater than or equal to 2 mol % and less than or equal to 10 mol %, greater than or equal to 2 mol % and less than or equal to 9 mol %, greater than or equal to 2 mol % and less than or equal to 8 mol %, greater than or equal to 2 mol % and less than or equal to 7 mol %, or even greater than or equal to 2 mol % and less than or equal to 6 mol %, or any and all sub-ranges formed from any of these endpoints.

The glass compositions and the glass articles described herein may further include other alkaline earth oxides in addition to MgO, such as CaO, SrO, and/or BaO. CaO, SrO, and BaO, like MgO, improve the meltability of the glass compositions and increase the chemical durability of the glass composition, in addition to influencing the CTE.

In embodiments, the glass composition used to form glass articles described herein may comprise greater than or equal to 0.1 mol % and less than or equal to 10 mol % CaO. In embodiments, the concentration of CaO in the glass composition may be greater than or equal to 0 mol %, greater than or equal to 0.1 mol %, greater than or equal to 0.5 mol %, or even greater than or equal to 1 mol %. In embodiments, the concentration of CaO in the glass composition may be less than or equal to 10 mol %, less than or equal to 7 mol %, less than or equal to 5 mol %, or even less than or equal to 3 mol %. In embodiments, the concentration of CaO in the glass composition may be greater than or equal to 0 mol % and less than or equal to 10 mol %, greater than or equal to 0 mol % and less than or equal to 7 mol %, greater than or equal to 0 mol % and less than or equal to 5 mol %, greater than or equal to 0 mol % and less than or equal to 3 mol %, greater than or equal to 0.1 mol % and less than or equal to 10 mol %, greater than or equal to 0.1 mol % and less than or equal to 7 mol %, greater than or equal to 0.1 mol % and less than or equal to 5 mol %, greater than or equal to 0.1 mol % and less than or equal to 3 mol %, greater than or equal to 0.5 mol % and less than or equal to 10 mol %, greater than or equal to 0.5 mol % and less than or equal to 7 mol %, greater than or equal to 0.5 mol % and less than or equal to 5 mol %, greater than or equal to 0.5 mol % and less than or equal to 3 mol %, greater than or equal to 1 mol % and less than or equal to 10 mol %, greater than or equal to 1 mol % and less than or equal to 7 mol %, greater than or equal to 1 mol % and less than or equal to 5 mol %, or even greater than or equal to 1 mol % and less than or equal to 3 mol %, or any and all sub-ranges formed from any of these endpoints. In embodiments, the glass composition and the resultant glass article may be substantially free or free of CaO.

In embodiments, the glass composition used to form glass articles described herein may comprise greater than or equal to 0.1 mol % and less than or equal to 5 mol % SrO. In embodiments, the concentration of SrO in the glass composition may be greater than or equal to 0 mol %, greater than or equal to 0.1 mol %, or even greater than or equal to 0.5 mol %. In embodiments, the concentration of SrO in the glass composition may be less than or equal to 5 mol %, less than or equal to 3 mol %, or even less than or equal to 1 mol %. In embodiments, the concentration of SrO in the glass composition may be greater than or equal to 0 mol % and less than or equal to 5 mol %, greater than or equal to 0 mol % and less than or equal to 3 mol %, greater than or equal to 0 mol % and less than or equal to 1 mol %, greater than or equal to 0.1 mol % and less than or equal to 5 mol %, greater than or equal to 0.1 mol % and less than or equal to 3 mol %, greater than or equal to 0.1 mol % and less than or equal to 1 mol %, greater than or equal to 0.5 mol % and less than or equal to 5 mol %, greater than or equal to 0.5 mol % and less than or equal to 3 mol %, or even greater than or equal to 0.5 mol % and less than or equal to 1 mol %, or any and all sub-ranges formed from any of these endpoints. In embodiments, the glass composition and the resultant glass article may be substantially free or free of SrO.

In embodiments, the glass composition and the resultant glass article may comprise greater than or equal to 0.1 mol % and less than or equal to 3 mol % BaO. In embodiments, the concentration of BaO in the glass composition used to form glass articles described herein may be greater than or equal to 0 mol %, greater than or equal to 0.1 mol %, greater than or equal to 0.5 mol %, or even greater than or equal to 1 mol %. In embodiments, the concentration of BaO in the glass composition may be less than or equal to 3 mol % or even less than or equal to 2 mol %. In embodiments, the concentration of BaO in the glass composition may be greater than or equal to 0 mol % and less than or equal to 3 mol %, greater than or equal to 0 mol % and less than or equal to 2 mol %, greater than or equal to 0.1 mol % and less than or equal to 3 mol %, greater than or equal to 0.1 mol % and less than or equal to 2 mol %, greater than or equal to 0.5 mol % and less than or equal to 3 mol %, greater than or equal to 0.5 mol % and less than or equal to 2 mol %, greater than or equal to 1 mol % and less than or equal to 3 mol %, or even greater than or equal to 1 mol % and less than or equal to 2 mol %, or any and all sub-ranges formed from any of these endpoints. In embodiments, the glass composition and the resultant glass article may be substantially free or free of BaO.

As used herein, RO is the sum (in mol %) of MgO, CaO, SrO, and BaO (i.e., RO═MgO (mol %)+CaO (mol %)+SrO (mol %)+BaO (mol %)) present in the glass composition and the resultant glass article. In embodiments, the concentration of RO in the glass composition used to form glass articles described herein greater than or equal to 0.25 mol %, greater than or equal to 0.5 mol %, greater than or equal to 1 mol %, or even greater than or equal to 3 mol %. In embodiments, the concentration of RO in the glass composition less than or equal to 16 mol %, less than or equal to 13 mol %, less than or equal to 10 mol %, or even less than or equal to 7 mol %. In embodiments, the concentration of RO in the glass composition greater than or equal to 0.25 mol % and less than or equal to 16 mol %, greater than or equal to 0.25 mol % and less than or equal to 13 mol %, greater than or equal to 0.25 mol % and less than or equal to 10 mol %, greater than or equal to 0.25 mol % and less than or equal to 7 mol %, greater than or equal to 0.5 mol % and less than or equal to 16 mol %, greater than or equal to 0.5 mol % and less than or equal to 13 mol %, greater than or equal to 0.5 mol % and less than or equal to 10 mol %, greater than or equal to 0.5 mol % and less than or equal to 7 mol %, greater than or equal to 1 mol % and less than or equal to 16 mol %, greater than or equal to 1 mol % and less than or equal to 13 mol %, greater than or equal to 1 mol % and less than or equal to 10 mol %, greater than or equal to 1 mol % and less than or equal to 7 mol %, greater than or equal to 3 mol % and less than or equal to 16 mol %, greater than or equal to 3 mol % and less than or equal to 13 mol %, greater than or equal to 3 mol % and less than or equal to 10 mol %, or even greater than or equal to 3 mol % and less than or equal to 7 mol %, or any and all sub-ranges formed from any of these endpoints.

Na₂O facilitates melting of the glass composition and lowers the softening point of the glass composition, thereby offsetting the increase in the softening point due to higher concentrations of SiO₂ and/or Al2O₃ in the glass composition. Na₂O also assists in improving the chemical durability of the glass composition and tuning the CTE to a desired value. In embodiments, the glass composition used to form glass articles described herein may comprise greater than or equal to 0.25 mol % and less than or equal to 10 mol % Na₂O. In embodiments, the glass composition may comprise greater than 0.5 mol % and less than or equal to 9 mol % Na₂O. In embodiments, the glass composition may comprise greater than or equal to 0.75 mol % and less than or equal to 8 mol % Na₂O. In embodiments, the concentration of Na₂O in the glass composition may be greater than or equal to 0.25 mol %, greater than or equal to 0.5 mol %, greater than or equal to 0.75 mol %, or even greater than or equal to 1 mol %. In embodiments, the concentration of Na₂O in the glass composition may be less than or equal to 10 mol %, less than or equal to 9 mol %, less than or equal to 8 mol %, less than or equal to 7 mol %, or even less than or equal to 6 mol %. In embodiments, the concentration of Na₂O in the glass composition may be greater than or equal to 0.25 mol % and less than or equal to 10 mol %, greater than or equal to 0.25 mol % and less than or equal to 9 mol %, greater than or equal to 0.25 mol % and less than or equal to 8 mol %, greater than or equal to 0.25 mol % and less than or equal to 7 mol %, greater than or equal to 0.25 mol % and less than or equal to 6 mol %, greater than or equal to 0.5 mol % and less than or equal to 10 mol %, greater than or equal to 0.5 mol % and less than or equal to 9 mol %, greater than or equal to 0.5 mol % and less than or equal to 8 mol %, greater than or equal to 0.5 mol % and less than or equal to 7 mol %, greater than or equal to 0.5 mol % and less than or equal to 6 mol %, greater than or equal to 0.75 mol % and less than or equal to 10 mol %, greater than or equal to 0.75 mol % and less than or equal to 9 mol %, greater than or equal to 0.75 mol % and less than or equal to 8 mol %, greater than or equal to 0.75 mol % and less than or equal to 7 mol %, greater than or equal to 0.75 mol % and less than or equal to 6 mol %, greater than or equal to 1 mol % and less than or equal to 10 mol %, greater than or equal to 1 mol % and less than or equal to 9 mol %, greater than or equal to 1 mol % and less than or equal to 8 mol %, greater than or equal to 1 mol % and less than or equal to 7 mol %, or even greater than or equal to 1 mol % and less than or equal to 6 mol %, or any and all sub-ranges formed from any of these endpoints.

The glass compositions and the glass articles described herein may further include other alkali oxides in addition to Na₂O, such as Li₂O and K₂O. Li₂O and K₂O, like Na₂O, facilitate melting of the glass composition and lower the softening point of the glass composition, thereby offsetting the increase in the softening point due to higher concentrations of SiO₂ and/or Al₂O₃ in the glass composition. Li₂O and K₂O also assist in improving the chemical durability of the glass composition and tuning the CTE to a desired value.

In embodiments, the glass composition and the resultant glass article may comprise greater than or equal to 0 mol % and less than or equal to 2 mol % Li₂O. In embodiments, the glass composition used to form glass articles described herein may comprise greater than or equal to 0.1 mol % and less than or equal to 1.75 mol % Li₂O. In embodiments, the concentration of Li₂O in the glass composition may be greater than or equal to 0 mol %, greater than or equal to 0.1 mol, or even greater than or equal to 0.5 mol %. In embodiments, the concentration of Li₂O in the glass composition may be less than or equal to 2 mol %, less than or equal to 1.75 mol %, or even less than or equal to 1.5 mol %. In embodiments, the concentration of Li₂O in the glass composition may be greater than or equal to 0 mol % and less than or equal to 2 mol %, greater than or equal to 0 mol % and less than or equal to 1.75 mol %, greater than or equal to 0 mol % and less than or equal to 1.5 mol %, greater than or equal to 0.1 mol % and less than or equal to 2 mol %, greater than or equal to 0.1 mol % and less than or equal to 1.75 mol %, greater than or equal to 0.1 mol % and less than or equal to 1.5 mol %, greater than or equal to 0.5 mol % and less than or equal to 2 mol %, greater than or equal to 0.5 mol % and less than or equal to 1.75 mol %, or even greater than or equal to 0.5 mol % and less than or equal to 1.5 mol %, or any and all sub-ranges formed from any of these endpoints. In embodiments, the glass composition and the resultant glass article may be substantially free or free of Li₂O.

In embodiments, the glass composition and the resultant glass article may comprise greater than or equal to 0.1 mol % and less than or equal to 5 mol % K₂O. In embodiments, the concentration of K₂O in the glass composition used to form glass articles described herein may be greater than or equal to 0 mol %, greater than or equal to 0.1 mol %, greater than or equal to 0.5 mol %, or even greater than or equal to 1 mol %. In embodiments, the concentration of K₂O in the glass composition may be less than or equal to 5 mol %, less than or equal to 4 mol %, or even less than or equal to 3 mol %. In embodiments, the concentration of K₂O in the glass composition may be greater than or equal to 0 mol % and less than or equal to 5 mol %, greater than or equal to 0 mol % and less than or equal to 4 mol %, greater than or equal to 0 mol % and less than or equal to 3 mol %, greater than or equal to 0.1 mol % and less than or equal to 5 mol %, greater than or equal to 0.1 mol % and less than or equal to 4 mol %, greater than or equal to 0.1 mol % and less than or equal to 3 mol %, greater than or equal to 0.5 mol % and less than or equal to 5 mol %, greater than or equal to 0.5 mol % and less than or equal to 4 mol %, greater than or equal to 0.5 mol % and less than or equal to 3 mol %, greater than or equal to 1 mol % and less than or equal to 5 mol %, greater than or equal to 1 mol % and less than or equal to 4 mol %, or even greater than or equal to 1 mol % and less than or equal to 3 mol %, or any and all sub-ranges formed from any of these endpoints. In embodiments, the glass composition and the resultant glass article may be substantially free or free of K₂O.

As used herein, R₂O is the sum (in mol %) of Na₂O, K₂O, and Li₂O (i.e., R₂O═Na₂O (mol %)+K₂O (mol %)+Li₂O (mol %)) present in the glass composition and the resultant glass article. In embodiments, the concentration of R₂O in the glass composition used to form glass articles disclosed herein may be greater than or equal to 0.25 mol %, greater than or equal to 1 mol %, greater than or equal to 3 mol %, or even greater than or equal to 5 mol %. In embodiments, the concentration of R₂O in the glass composition may be less than or equal to 12 mol %, less than or equal to 10 mol %, or even less than or equal to 8 mol % In embodiments, the concentration of R₂O in the glass composition may be greater than or equal to 0.25 mol % and less than or equal to 12 mol %, greater than or equal to 0.25 mol % and less than or equal to 10 mol %, greater than or equal to 0.25 mol % and less than or equal to 8 mol %, greater than or equal to 1 mol % and less than or equal to 12 mol %, greater than or equal to 1 mol % and less than or equal to 10 mol %, greater than or equal to 1 mol % and less than or equal to 8 mol %, greater than or equal to 3 mol % and less than or equal to 12 mol %, greater than or equal to 3 mol % and less than or equal to 10 mol %, greater than or equal to 3 mol % and less than or equal to 8 mol %, greater than or equal to 5 mol % and less than or equal to 12 mol %, greater than or equal to 5 mol % and less than or equal to 10 mol %, greater than or equal to 5 mol % and less than or equal to 8 mol %.

In embodiments, the sum (in mol %) of R₂O and RO (i.e., R2O+RO) in the glass composition used to form glass articles disclosed herein may be greater than or equal to 0.5 mol %, greater than or equal to 1 mol %, greater than or equal to 3 mol %, or even greater than or equal to 5 mol %. In embodiments, R₂O+RO in the glass composition may be less than or equal to 25 mol %, less than or equal to or equal to 20 mol %, or even less than or equal to 15 mol %. In embodiments, R₂O+RO in the glass composition may be greater than or equal to 0.5 mol % and less than or equal to 25 mol %, greater than or equal to 0.5 mol % and less than or equal to 20 mol %, greater than or equal to 0.5 mol % and less than or equal to 15 mol %, greater than or equal to 1 mol % and less than or equal to 25 mol %, greater than or equal to 1 mol % and less than or equal to 20 mol %, greater than or equal to 1 mol % and less than or equal to 15 mol %, greater than or equal to 3 mol % and less than or equal to 25 mol %, greater than or equal to 3 mol % and less than or equal to 20 mol %, greater than or equal to 3 mol % and less than or equal to 15 mol %, greater than or equal to 5 mol % and less than or equal to 25 mol %, greater than or equal to 5 mol % and less than or equal to 20 mol %, or even greater than or equal to 5 mol % and less than or equal to 15 mol %, or any and all sub-ranges formed from any of these endpoints.

As described herein the glass compositions described herein include La₂O₃ and/or Y₂O₃ to achieve a desired Young's modulus (e.g., greater than or equal to 82 MPa). Increasing the concentration of La₂O₃ and/or Y₂O₃ increases the Young's modulus of the resultant glass article. In embodiments, the sum (in mol %) of La₂O₃ and Y₂O₃ (i.e., La₂O₃ (mol %)+Y₂O₃ (mol %) in the glass composition used to form glass articles disclosed herein may be greater than or equal to 2 mol % and less than or equal to 9 mol %. In embodiments, La₂O₃+Y₂O₃ in the glass composition may be greater than or equal to 3 mol % and less than or equal to 8 mol %. In embodiments, La₂O₃+Y₂O₃ in the glass composition may be greater than or equal to 2 mol %, greater than or equal to 3 mol %, or even greater than or equal to 4 mol %. In embodiments, La₂O₃+Y₂O₃ in the glass composition may be less than or equal to 9 mol %, less than or equal to 8 mol %, less than or equal to 7 mol %, or even less than or equal to 6 mol %. In embodiments, La₂O₃+Y₂O₃ in the glass composition may be greater than or equal to 2 mol % and less than or equal to 9 mol %, greater than or equal to 2 mol % and less than or equal to 8 mol %, greater than or equal to 2 mol % and less than or equal to 7 mol %, greater than or equal to 2 mol % and less than or equal to 6 mol %, greater than or equal to 3 mol % and less than or equal to 9 mol %, greater than or equal to 3 mol % and less than or equal to 8 mol %, greater than or equal to 3 mol % and less than or equal to 7 mol %, greater than or equal to 3 mol % and less than or equal to 6 mol %, greater than or equal to 4 mol % and less than or equal to 9 mol %, greater than or equal to 4 mol % and less than or equal to 8 mol %, greater than or equal to 4 mol % and less than or equal to 7 mol %, or even greater than or equal to 4 mol % and less than or equal to 6 mol %, or any and all sub-ranges formed from any of these endpoints.

In embodiments, the glass composition used to form glass articles disclosed herein may comprise greater than or equal to 0 mol % and less than or equal to 9 mol % La₂O₃. In embodiments, the glass composition may comprise greater than or equal to 2 mol % and less than or equal to 9 mol % La₂O₃. In embodiments, the concentration of La₂O₃ in the glass composition may be greater than or equal to 0 mol %, greater than or equal to 2 mol %, or even greater than or equal to 4 mol %. In embodiments, the concentration of La₂O₃ in the glass composition may be less than or equal to 9 mol %, less than or equal to 8 mol %, or even less than or equal to 7 mol %. In embodiments, the concentration of La₂O₃ in the glass composition may be greater than or equal to 0 mol % and less than or equal to 9 mol %, greater than or equal to 0 mol % and less than or equal to 8 mol %, greater than or equal to 0 mol % and less than or equal to 7 mol %, greater than or equal to 2 mol % and less than or equal to 9 mol %, greater than or equal to 2 mol % and less than or equal to 8 mol %, greater than or equal to 2 mol % and less than or equal to 7 mol %, greater than or equal to 4 mol % and less than or equal to 9 mol %, greater than or equal to 4 mol % and less than or equal to 8 mol %, or even greater than or equal to 4 mol % and less than or equal to 7 mol %, or any and all sub-ranges formed from any of these endpoints. In embodiments, the glass composition and the resultant glass article may be substantially free or free of La₂O₃.

In embodiments, the glass composition and the resultant glass article may comprise greater than or equal to 0 mol % and less than or equal to 9 mol % Y₂O₃. In embodiments, the glass composition used to form glass articles disclosed herein may comprise greater than or equal to 2 mol % and less than or equal to 9 mol % Y₂O₃. In embodiments, the concentration of Y₂O₃ in the glass composition may be greater than or equal to 0 mol %, greater than or equal to 2 mol %, or even greater than or equal to 4 mol %. In embodiments, the concentration of Y₂O₃ in the glass composition may be less than or equal to 9 mol %, less than or equal to 8 mol %, or even less than or equal to 7 mol %. In embodiments, the concentration of Y₂O₃ in the glass composition may be greater than or equal to 0 mol % and less than or equal to 9 mol %, greater than or equal to 0 mol % and less than or equal to 8 mol %, greater than or equal to 0 mol % and less than or equal to 7 mol %, greater than or equal to 2 mol % and less than or equal to 9 mol %, greater than or equal to 2 mol % and less than or equal to 8 mol %, greater than or equal to 2 mol % and less than or equal to 7 mol %, greater than or equal to 4 mol % and less than or equal to 9 mol %, greater than or equal to 4 mol % and less than or equal to 8 mol %, or even greater than or equal to 4 mol % and less than or equal to 7 mol %, or any and all sub-ranges formed from any of these endpoints. In embodiments, the glass composition and the resultant glass article may be substantially free or free of Y₂O₃.

As described herein, increasing the ratio of La₂O₃+Y₂O₃ to R₂O+RO (i.e., (La₂O₃+Y₂O₃)/(R₂O+RO)) increases the Young's modulus of the resultant glass article. In embodiments, (La₂O₃+Y₂O₃)/(R₂O+RO) in the glass composition and the resultant glass article may be greater than or equal to 0.1 and less than or equal to 2. In embodiments, (La₂O₃+Y₂O₃)/(R₂O+RO) in the glass composition used to form glass articles disclosed herein may be greater than or equal to 0.1, greater than or equal to 0.2, greater than or equal to 0.3, greater than or equal to 0.4, or even greater than or equal to 0.5. In embodiments, (La₂O₃+Y₂O₃)/(R₂O+RO) in the glass composition may be less than or equal to 2, less than or equal to 1.8, less than or equal to 1.6, less than or equal to 1.4, less than or equal to 1.2, or even less than or equal to 1. In embodiments, (La₂O₃+Y₂O₃)/(R₂O+RO) in the glass composition may be greater than or equal to 0.1 and less than or equal to 2, greater than or equal to 0.1 and less than or equal to 1.8, greater than or equal to 0.1 and less than or equal to 1.6, greater than or equal to 0.1 and less than or equal to 1.4, greater than or equal to 0.1 and less than or equal to 1.2, greater than or equal to 0.1 and less than or equal to 1, greater than or equal to 0.2 and less than or equal to 2, greater than or equal to 0.2 and less than or equal to 1.8, greater than or equal to 0.2 and less than or equal to 1.6, greater than or equal to 0.2 and less than or equal to 1.4, greater than or equal to 0.2 and less than or equal to 1.2, greater than or equal to 0.2 and less than or equal to 1, greater than or equal to 0.3 and less than or equal to 2, greater than or equal to 0.3 and less than or equal to 1.8, greater than or equal to 0.3 and less than or equal to 1.6, greater than or equal to 0.3 and less than or equal to 1.4, greater than or equal to 0.3 and less than or equal to 1.2, greater than or equal to 0.3 and less than or equal to 1, greater than or equal to 0.4 and less than or equal to 2, greater than or equal to 0.4 and less than or equal to 1.8, greater than or equal to 0.4 and less than or equal to 1.6, greater than or equal to 0.4 and less than or equal to 1.4, greater than or equal to 0.4 and less than or equal to 1.2, greater than or equal to 0.4 and less than or equal to 1, greater than or equal to 0.5 and less than or equal to 2, greater than or equal to 0.5 and less than or equal to 1.8, greater than or equal to 0.5 and less than or equal to 1.6, greater than or equal to 0.5 and less than or equal to 1.4, greater than or equal to 0.5 and less than or equal to 1.2, or even greater than or equal to 0.5 and less than or equal to 1, or any and all sub-ranges formed from any of these endpoints.

In embodiments, excess R₂O and RO in the glass composition used to form glass articles disclosed herein (i.e., (R₂O (mol %)+RO (mol %))/Al₂O₃ (mol %) >1.0) may result in the formation of non-bridging oxygen, which may increase the CTE of the resultant glass article. As described herein, La₂O₃ and Y₂O₃ may be added to increase the Young's modulus as La₂O₃ and Y₂O₃ are generally 5- and 6-fold coordinated with oxygen, whereas R₂O and RO may only be 4-fold coordinated with oxygen. A larger amount of bonds in the resultant glass article (i.e., higher coordination species) generally increases the Young's modulus. Accordingly, in embodiments, the ratio of the sum (in mol %) of La₂O₃, T₂O₃, R20, and RO (i.e., La₂O₃ (mol %)+Y₂O₃ (mol %)+R₂O (mol %)+RO (mol %)) to Al₂O₃ (i.e., (La₂O₃+Y₂O₃+R₂O+RO)/Al₂O₃) in the glass composition may be greater than or equal to 0.5 and less than or equal to 2.5. In embodiments, (La₂O₃+Y₂O₃+R₂O+RO)/Al₂O₃) in the glass composition may be greater than or equal to 0.75 and less than or equal to 2.25. In embodiments, (La₂O₃+Y₂O₃+R₂O+RO)/Al₂O₃) in the glass composition may be greater than or equal to 0.5, greater than or equal to 0.75, or even greater than or equal to 1. In embodiments, (La₂O₃+Y₂O₃+R₂O+RO)/Al₂O₃) in the glass composition may be less than or equal to 2.5, less than or equal to 2.25, or even less than or equal to 2. In embodiments, (La₂O₃+Y₂O₃+R₂O+RO)/Al₂O₃) in the glass composition may be greater than or equal to 0.5 and less than or equal to 2.5, greater than or equal to 0.5 and less than or equal to 2.25, greater than or equal to 0.5 and less than or equal to 2, greater than or equal to 0.75 and less than or equal to 2.5, greater than or equal to 0.75 and less than or equal to 2.25, greater than or equal to 0.75 and less than or equal to 2, greater than or equal to 1 and less than or equal to 2.5, greater than or equal to 1 and less than or equal to 2.25, or even greater than or equal to 1 and less than or equal to 2, or any and all sub-ranges formed from any of these endpoints.

The glass compositions and resultant glass articles described herein may further comprise B₂O₃. B₂O₃ may be added to glass compositions to make the viscosity-temperature curve less steep as well as lowering the entire curve, thereby improving the formability and the softening the glass article. In embodiments, the glass compositions and the resultant glass article may comprise greater than or equal to 0.5 mol % and less than or equal to 6 mol % B₂O₃. In embodiments, the concentration of B₂O₃ in the glass composition and the resultant glass article may be greater than or equal to 0 mol %, greater than or equal to 0.5 mol %, greater than or equal to 1 mol %, or even greater than or equal to 2 mol %. In embodiments, the concentration of B₂O₃ in the glass composition used to form glass articles disclosed herein may be less than or equal to 6 mol %, less than or equal to 5 mol %, or even less than or equal to 4 mol %. In embodiments, the concentration of B₂O₃ in the glass composition may be greater than or equal to 0 mol % and less than or equal to 6 mol %, greater than or equal to 0 mol % and less than or equal to 5 mol %, greater than or equal to 0 mol % and less than or equal to 4 mol %, greater than or equal to 0.5 mol % and less than or equal to 6 mol %, greater than or equal to 0.5 mol % and less than or equal to 5 mol %, greater than or equal to 0.5 mol % and less than or equal to 4 mol %, greater than or equal to 1 mol % and less than or equal to 6 mol %, greater than or equal to 1 mol % and less than or equal to 5 mol %, greater than or equal to 1 mol % and less than or equal to 4 mol %, greater than or equal to 2 mol % and less than or equal to 6 mol %, greater than or equal to 2 mol % and less than or equal to 5 mol %, or even greater than or equal to 2 mol % and less than or equal to 4 mol %, or any and all sub-ranges formed from any of these endpoints. In embodiments, the glass composition and the resultant glass article may be substantially free or free of B₂O₃.

The glass compositions and the resultant glass articles described herein may further comprise one or more fining agents. In embodiments, the fining agents may include, for example, SnO₂. In embodiments, the glass composition and the resultant glass article may comprise greater than 0 mol % and less than or equal to 1 mol % SnO₂. In embodiments, the concentration of SnO₂ in the glass composition used to form glass articles disclosed herein may be greater than or equal to 0 mol % or even greater than or equal to 0.1 mol %. In embodiments, the concentration of SnO₂ in the glass composition may be less than or equal to 1 mol % or even less than or equal to 0.5 mol %. In embodiments, the concentration of SnO₂ in the glass composition may be greater than or equal to 0 mol % and less than or equal to 1 mol %, greater than or equal to 0 mol % and less than or equal to 0.5 mol %, greater than or equal to 0.1 mol % and less than or equal to 1 mol %, or even greater than or equal to 0.1 mol % and less than or equal to 0.5 mol %, or any and all sub-ranges formed from any of these endpoints. In embodiments, the glass composition and the resultant glass article may be substantially free or free of SnO₂.

In embodiments, the glass composition and the resultant glass article may be substantially free or free of fluoride or fluoride containing components.

In embodiments, the glass compositions and the resultant glass articles described herein may further include tramp materials such as TiO₂, MnO, MoO₃, WO₃, T₂O₃, CdO, As2O₃, sulfur-based compounds, such as sulfates, halogens, or combinations thereof. In embodiments, the glass composition and the resultant glass article may be substantially free or free of tramp materials such as TiO₂, MnO, MoO₃, WO₃, T₂O₃, CdO, As₂O₃, sulfur-based compounds, such as sulfates, halogens, or combinations thereof. In embodiments, antimicrobial components, chemical fining agents, or other additional components may be included in the glass composition and the resultant glass article.

As described herein, the glass compositions described herein are compatible with the thermal packaging processes employed by various manufactures, while allowing the properties of resultant glass articles formed from the glass compositions, including the CTE and Young's modulus, to be tuned to meet the specification of individual manufactures. In embodiments, the resultant glass article may have a CTE greater than or equal to 45×10⁻⁷PC and less than or equal to 70×10⁻⁷/° C. In embodiments, the resultant glass article may have a CTE greater than or equal to 45×10⁻⁷° C., greater than or equal to 47×10⁻⁷° C., greater than or equal to 49×10⁻⁷° C., or even greater than or equal to 51×10⁻⁷° C. In embodiments, the resultant glass article may have a CTE less than or equal to 70×10⁻⁷° C., less than or equal to 67×10⁻⁷° C., less than or equal to 65×10⁻⁷° C., less than or equal to 63×10⁻⁷° C., less than or equal to 61×10⁻⁷° C., or even less than or equal to 59×10⁻⁷° C. In embodiments, the resultant glass article may have a CTE greater than or equal to 45×10⁻⁷° C. and less than or equal to 70×10⁻⁷° C., greater than or equal to 45×10⁻⁷° C. and less than or equal to 67×10⁻⁷° C., greater than or equal to 45×10⁻⁷° C. and less than or equal to 65×10⁻⁷° C., greater than or equal to 45×10⁻⁷° C. and less than or equal to 63×10⁻⁷° C., greater than or equal to 45×10⁻⁷° C. and less than or equal to 61×10⁻⁷° C., greater than or equal to 45×10⁻⁷° C. and less than or equal to 59×10⁻⁷° C., greater than or equal to 47×10⁻⁷° C. and less than or equal to 70×10⁻⁷° C., greater than or equal to 47×10⁻⁷° C. and less than or equal to 67×10⁻⁷° C., greater than or equal to 47×10⁻⁷° C. and less than or equal to 65×10⁻⁷° C., greater than or equal to 47×10⁻⁷° C. and less than or equal to 63×10⁻⁷° C., greater than or equal to 47×10⁻⁷° C. and less than or equal to 61×10⁻⁷° C., greater than or equal to 47×10⁻⁷° C. and less than or equal to 59×10⁻⁷° C., greater than or equal to 49×10⁻⁷° C. and less than or equal to 70×10⁻⁷° C., greater than or equal to 49×10⁻⁷° C. and less than or equal to 67×10⁻⁷° C., greater than or equal to 49×10⁻⁷° C. and less than or equal to 65×10⁻⁷° C., greater than or equal to 49×10⁻⁷° C. and less than or equal to 63×10⁻⁷° C., greater than or equal to 49×10⁻⁷° C. and less than or equal to 61×10⁻⁷° C., greater than or equal to 49×10⁻⁷° C. and less than or equal to 59×10⁻⁷° C., greater than or equal to 51×10⁻⁷° C. and less than or equal to 70×10⁻⁷° C., greater than or equal to 51×10⁻⁷° C. and less than or equal to 67×10⁻⁷° C., greater than or equal to 51×10⁻⁷° C. and less than or equal to 65×10⁻⁷° C., greater than or equal to 51×10⁻⁷° C. and less than or equal to 63×10⁻⁷° C., greater than or equal to 51×10⁻⁷° C. and less than or equal to 61×10⁻⁷° C., or even greater than or equal to 51×10⁻⁷° C. and less than or equal to 59×10⁻⁷° C., or any and all sub-ranges formed from any of these endpoints.

In embodiments, the resultant glass article formed from glass compositions disclosed herein may have a Young's modulus greater than or equal to 82 GPa which may minimize flexing of the glass article during processing and prevent damage to devices attached to the glass article, such as when the glass article is configured for use as a carrier substrate for electronic devices (e.g., integrated circuit components). In embodiments, the resultant glass article may have a Young's modulus greater than or equal to 82 GPa, greater than or equal to 84 GPa, or even greater than 86 GPa. In embodiments, the resultant glass article may have a Young's modulus less than or equal to less than or equal to 100 GPa, less than or equal to 95 GPa, or even less than or equal to 80 GPa. In embodiments, the resultant glass article may have a Young's modulus greater than or equal to 82 GPa and less than or equal to 100 GPa, greater than or equal to 82 GPa and less than or equal to 95 GPa, greater than or equal to 82 GPa and less than or equal to 90 GPa, greater than or equal to 84 GPa and less than or equal to 100 GPa, greater than or equal to 84 GPa and less than or equal to 95 GPa, greater than or equal to 84 GPa and less than or equal to 90 GPa, greater than or equal to 86 GPa and less than or equal to 100 GPa, greater than or equal to 86 GPa and less than or equal to 95 GPa, or even greater than or equal to 86 GPa and less than or equal to 90 GPa, or any and all sub-ranges formed from any of these endpoints.

The liquidus viscosity of the glass composition may also be adjusted to enable the glass to be melted in a variety of processing facilities (e.g., thin rolled sheet forming method). In embodiments, the glass composition may have a liquidus viscosity greater than or equal to 750 poise. In embodiments, the glass composition may have a liquidus viscosity greater than or equal to 1000 poise. In embodiments, the glass composition may have a liquidus viscosity greater than or equal to 3000 poise. In embodiments, the glass composition may have a liquidus viscosity greater than or equal to 750 poise. In embodiments, the glass composition may have a liquidus viscosity greater than or equal to 750 poise, greater than or equal to 1000 poise, or even greater than or equal to 3000 poise. In embodiments, the glass composition may have a liquidus viscosity, less than or equal to 50000 poise, less than or equal to 30000 poise, or even less than or equal to 10000 poise. In embodiments, the glass composition may have a liquidus viscosity greater than or equal to 750 poise and less than or equal to 50000 poise, greater than or equal to 750 poise and less than or equal to 30000 poise, greater than or equal to 750 poise and less than or equal to 10000 poise, greater than or equal to 1000 poise and less than or equal to 50000 poise, greater than or equal to 1000 poise and less than or equal to 30000 poise, greater than or equal to 1000 poise and less than or equal to 10000 poise, greater than or equal to 3000 poise and less than or equal to 50000 poise, greater than or equal to 3000 poise and less than or equal to 30000 poise, greater than or equal to 3000 poise and less than or equal to 10000 poise, or any and all sub-ranges formed from any of these endpoints.

In embodiments, resultant glass articles formed from glass compositions disclosed herein may have a coefficient of thermal expansion of the glass article is greater than or equal to 45×10⁻⁷/° C. and less than or equal to 70×10⁻⁷° C., a Young's modulus of the glass article is greater than or equal to 82 GPa, and a liquidus viscosity of the glass composition is greater than or equal to 3000 poise.

In embodiments, a carrier substrate, configured from the resultant glass articles formed from the glass compositions disclosed herein, may have a diameter greater than or equal to 100 mm and less than or equal to 300 mm and a thickness greater than or equal 0.3 mm and less than or equal to 2.5 mm. In embodiments, a method for forming a carrier substrate may comprise cutting (e.g., with a wire saw) a glass article (e.g., having a disk or boule shape) to the desired diameter and thickness, lapping the cut glass article (e.g., via Computer Numerical Control (CNC) machining), and polishing the lapped glass article to provide the carrier substrate. In other embodiments, the method for forming a carrier substrate may comprise cutting (e.g., via a Topside Reference System (TRS)) circles from a glass article, lapping the circles (e.g., via Computer Numerical Control (CNC) machining), and polishing the lapped circles to provide carrier substrates. In embodiments, the carrier substrates may be coated.

### EXAMPLES

In order that various embodiments be more readily understood, reference is made to the following examples, which illustrate various embodiments of the glass compositions and the glass articles formed therefrom described herein.

A base glass composition (C1) for an alkali/alkaline earth aluminosilicate glass article was selected to illustrate the principles disclosed herein. A base glass article formed from base glass composition (C1) had a CTE less than 45×10⁻⁷° C. The base glass composition was varied to produce several modified glass compositions (E1-E17) expected to form glass articles having a CTE greater than or equal to 45×10⁻⁷/° C. through various batch oxide component substitutions intended to reduce the cation field strength of the glass articles relative to the base glass article. The base and modified glass compositions were melted in covered Pt crucibles at a temperature between 1450° C. and 1475° C., poured into patties, and annealed to form glass articles. The glass articles were coarse ground, and then melted a second time to ensure good glass homogeneity. All glass articles were then characterized. In particular, X-ray fluorescence (XRF) was used to characterize the chemical composition, the coefficient of thermal expansion (CTE) was measured using dilatometry in accordance with ASTM E228-85, and Young's modulus was measured using resonant ultrasound spectroscopy (RUS) in accordance with ASTM C623.

Table 2 shows the comparative base glass composition (C1) and the example glass compositions (E1-E17) (in terms of mol %), along with liquidus viscosity of the glass composition, and CTE and Young's modulus for glass articles formed from each of the glass compositions.

TABLE 2

| Example | C1 | E1 | E2 | E3 | E4 | E5 | E6 | E7 | E8 |
|---|---|---|---|---|---|---|---|---|---|
| SiO₂ | 66.59 | 70.62 | 70.12 | 69.20 | 62.92 | 62.92 | 62.92 | 67.59 | 67.72 |
| Al₂O₃ | 16.52 | 13.19 | 12.69 | 12.65 | 10.29 | 10.29 | 10.29 | 16.52 | 16.63 |
| B₂O₃ | — | — | — | — | 3.95 | 3.95 | 3.95 | — | — |
| Li₂O | — | — | — | 1.02 | — | — | — | — | — |
| Na₂O | 6.06 | 4.87 | 5.87 | 5.84 | 1.04 | 2.04 | 2.25 | 5.06 | 4.96 |
| K₂O | — | 0.01 | 0.01 | 0.01 | 3.23 | 3.23 | 3.23 | — | 0.01 |
| MgO | 1.53 | 5.02 | 5.02 | 5.01 | 6.25 | 5.75 | 5.75 | 1.53 | 1.48 |
| CaO | 0.43 | 2.49 | 2.48 | 2.47 | 6.54 | 6.00 | 6.00 | 0.43 | 0.44 |
| SrO | 0.65 | 1.56 | 1.56 | 1.56 | 0.75 | 0.75 | 0.50 | 0.65 | 0.68 |
| BaO | 0.01 | — | — | — | 1.02 | 1.02 | 1.02 | 0.01 | — |
| La₂O₃ | 8.10 | 2.13 | 2.13 | 2.13 | 4.00 | 4.00 | 4.00 | 8.10 | 7.97 |
| Y₂O₃ | — | — | — | — | — | — | — | — | — |
| Fe₂O₃ | 0.01 | — | — | — | — | — | — | 0.01 | — |
| SnO₂ | — | — | — | — | — | — | — | — | — |
| La₂O₃ + Y₂O₃ | 8.10 | 2.13 | 2.13 | 2.13 | 4.00 | 4.00 | 4.00 | 8.10 | 7.97 |
| R₂O | 6.06 | 4.88 | 5.88 | 6.87 | 4.27 | 5.27 | 5.48 | 5.06 | 4.97 |
| RO | 2.62 | 9.07 | 9.06 | 9.04 | 14.56 | 13.52 | 13.27 | 2.62 | 2.61 |
| R₂O + RO | 8.68 | 13.95 | 14.94 | 15.91 | 18.83 | 18.79 | 18.75 | 7.68 | 7.58 |
| (La₂O₃ + Y₂O₃)/ | 0.93 | 0.15 | 0.14 | 0.13 | 0.21 | 0.21 | 0.21 | 1.05 | 1.05 |
| (R₂O + RO) | | | | | | | | | |
| (La₂O₃ + Y₂O₃ + | 1.02 | 1.22 | 1.35 | 1.43 | 2.22 | 2.21 | 2.21 | 0.96 | 0.93 |
| R₂O + RO)/Al₂O₃ | | | | | | | | | |
| CTE (×10⁻⁷/° C.) | 44.9 | 45.9 | 53.0 | 54.0 | 61.8 | 66.7 | 68.2 | 56.2 | 52.4 |
| Young's modulus | 95 | 84 | 83 | 84 | 83 | 82 | 82 | 88 | 88 |
| (GPa) | | | | | | | | | |
| Liquidus viscosity | 83661 | 44612 | 34899 | 28175 | 3611 | 4170 | 3026 | 1368 | 3638 |
| (poise) | | | | | | | | | |

| Example | E9 | E10 | E11 | E12 | E13 | E14 | E15 | E16 | E17 |
|---|---|---|---|---|---|---|---|---|---|
| SiO₂ | 67.64 | 67.76 | 67.54 | 67.60 | 67.60 | 67.59 | 67.59 | 67.59 | 66.54 |
| Al₂O₃ | 15.69 | 15.64 | 15.63 | 15.52 | 15.52 | 15.52 | 15.52 | 15.52 | 16.51 |
| B₂O₃ | — | — | — | 0.00 | 0.00 | 0.00 | 0.00 | 0.00 | 0.00 |
| Li₂O | — | — | — | 0.00 | 0.00 | 0.00 | 0.00 | 0.00 | 0.00 |
| Na₂O | 4.95 | 4.96 | 5.38 | 4.06 | 5.06 | 5.06 | 6.06 | 7.06 | 6.57 |
| K₂O | 0.98 | 1.97 | 0.98 | 1.00 | 1.00 | 2.00 | 1.00 | 1.00 | 3.25 |
| MgO | 2.47 | 1.95 | 2.02 | 3.53 | 2.53 | 2.00 | 2.00 | 1.00 | 1.03 |
| CaO | 1.56 | 1.01 | 1.58 | 1.53 | 1.53 | 1.00 | 1.00 | 1.00 | 0.00 |
| SrO | 0.68 | 0.67 | 0.67 | 0.65 | 0.65 | 0.65 | 0.65 | 0.65 | 0.00 |
| BaO | — | — | — | 0.00 | 0.00 | 0.00 | 0.00 | 0.00 | 0.00 |
| La₂O₃ | 5.92 | 5.91 | 6.09 | 0.00 | 0.00 | 0.00 | 0.00 | 0.00 | 0.00 |
| Y₂O₃ | — | — | — | 6.00 | 6.00 | 6.00 | 6.00 | 6.00 | 6.09 |
| Fe₂O₃ | — | — | — | 0.00 | 0.00 | 0.00 | 0.00 | 0.00 | 0.00 |
| SnO₂ | — | — | — | 0.10 | 0.10 | 0.10 | 0.10 | 0.10 | 0.01 |
| La₂O₃ + Y₂O₃ | 5.92 | 5.91 | 6.09 | 6.00 | 6.00 | 6.00 | 6.00 | 6.00 | 6.09 |
| R₂O | 5.93 | 6.93 | 6.36 | 5.06 | 6.06 | 7.06 | 7.06 | 8.06 | 9.82 |
| RO | 4.71 | 3.64 | 4.28 | 5.71 | 4.71 | 3.65 | 3.65 | 2.65 | 1.03 |
| R₂O + RO | 10.64 | 10.57 | 10.63 | 10.77 | 10.77 | 10.71 | 10.71 | 10.71 | 10.85 |
| (La₂O₃ + Y₂O₃)/ | 0.56 | 0.56 | 0.57 | 0.56 | 0.56 | 0.56 | 0.56 | 0.56 | 0.56 |
| (R₂O + RO) | | | | | | | | | |
| (La₂O₃ + Y₂O₃ + | 1.06 | 1.05 | 1.07 | 1.08 | 1.08 | 1.08 | 1.08 | 1.08 | 1.03 |
| R₂O + RO)/Al₂O₃ | | | | | | | | | |
| CTE (×10⁻⁷/° C.) | 55.1 | 59.7 | 57.8 | 48.2 | 51.4 | 55.0 | 54.4 | 57.6 | 63.5 |
| Young's modulus | 86 | 85 | 86 | 91 | 90 | 88 | 88 | 87 | 85 |
| (GPa) | | | | | | | | | |
| Liquidus viscosity | 7158 | 3051 | 3411 | — | 1023 | 844 | 877 | — | — |
| (poise) | | | | | | | | | |

For glass articles formed from each of the glass compositions provided in Table 2, the CTE was greater than or equal to 45×10⁻⁷° C. and less than or equal to 70×10⁻⁷° C. and the Young's modulus was greater than or equal to 82 GPa.

Note that as exemplified by glass articles formed from example glass compositions E1-E6, the CTE range from greater than or equal to 45×10⁻⁷/° C. and less than or equal to 70 x 10⁻⁷/° C. could be obtained by replacing La₂O₃ primarily with RO. Accordingly, the data provided in Tables 1 and 2 demonstrates that the CTE can be controlled by adjusting the overall cation field strength.

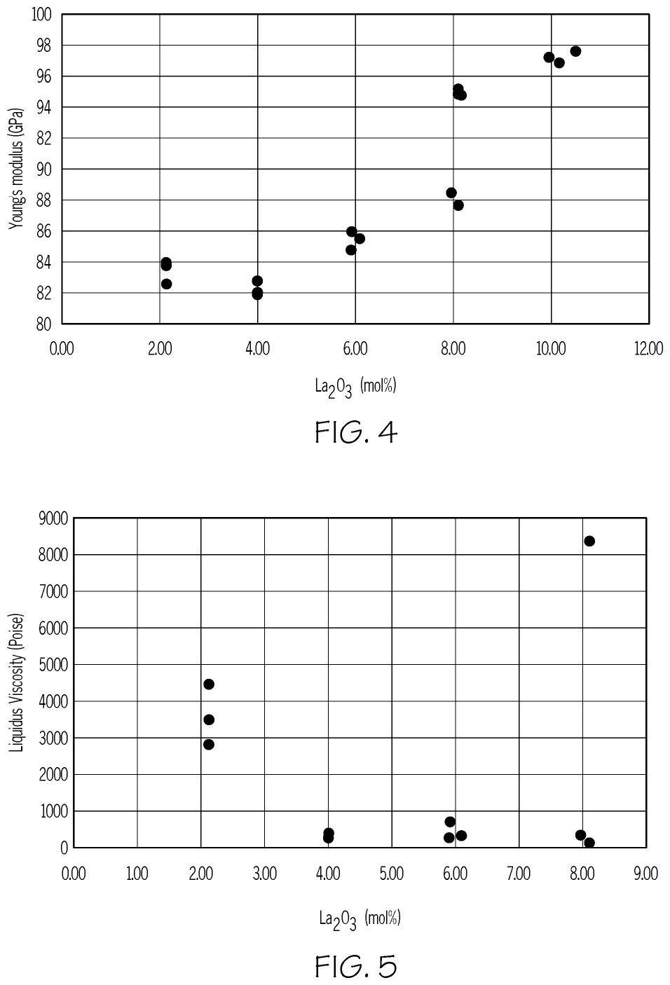

Referring now to FIGS. 4 and 5, as the La₂O₃ concentration of the example modified glass compositions was increased, the Young's modulus increased and the liquidus viscosity decreased. As exemplified in FIGS. 4 and 5, the amount of La₂O₃ may be modified to balance the desired values of Young's modulus and liquidus viscosity.

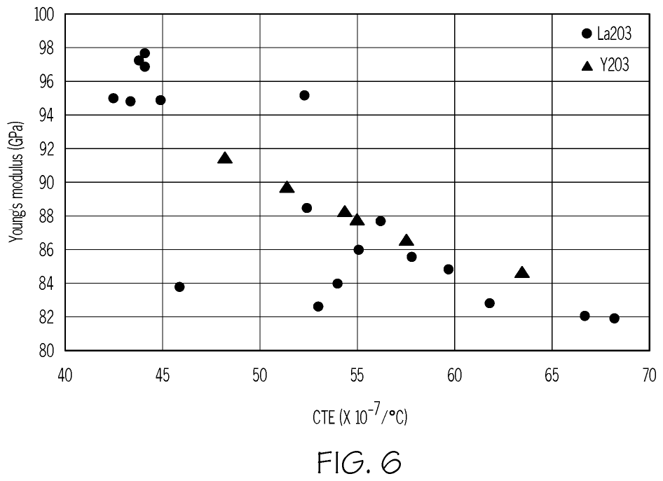

Referring now to FIG. 6, as Young's modulus of glass articles formed from the example modified glass compositions increased, the CTE generally decreased. As exemplified by FIG. 6, the amount of La₂O₃ and/or Y₂O₃ may be modified to balance the desired values of Young's modulus and CTE.

It will be apparent to those skilled in the art that various modifications and variations may be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

What is claimed is:

1. A glass article comprising:
greater than or equal to 60 mol % and less than or equal to 80 mol % SiO₂;
greater than or equal to 5 mol % and less than or equal to 25 mol % Al₂O₃;
greater than or equal to 0.25 mol % and less than or equal to 10 mol % MgO;
greater than or equal to 0.25 mol % and less than or equal to 10 mol % Na₂O;
greater than or equal to 0 mol % and less than or equal to 2 mol % Li₂O;
greater than or equal to 0 mol % and less than or equal to 9 mol % La₂O₃; and
greater than or equal to 0 mol % and less than or equal to 9 mol % T₂O₃, wherein La₂O₃+Y₂O₃ is greater than or equal to 2 mol % and less than or equal to 9 mol %, and
wherein (La₂O₃+Y₂O₃)/(R₂O+RO) is greater than or equal to 0.1 and less than or equal to 2, R₂O being a sum of Na₂O, Li₂O, and K₂O expressed in mol %, and RO being a sum of MgO, CaO, SrO, and BaO expressed in mol %.

2. The glass article of claim 1 comprising greater than 0.5 mol % and less than or equal to 9 mol % Na₂O.

3. The glass article of claim 1, wherein La₂O₃+Y₂O₃ is greater than or equal to 3 mol % and less than or equal to 8 mol %.

4. The glass article of claim 1, wherein (La₂O₃+Y₂O₃+R₂O+RO)/Al₂O₃ is greater than or equal to 0.5 and less than or equal to 2.5.

5. The glass article of claim 1 comprising greater than or equal to 0.5 mol % and less than or equal to 9 mol % MgO.

6. The glass article of claim 1 comprising greater than or equal to 2 mol % and less than or equal to 9 mol % La₂O₃.

7. The glass article of claim 1 comprising greater than or equal to 2 mol % and less than or equal to 9 mol % Y₂O₃.

8. The glass article of claim 1, wherein a coefficient of thermal expansion of the glass article is greater than or equal to 45×10⁻⁷/° C. and less than or equal to 70×10⁻⁷/° C., a Young's modulus of the glass article is greater than or equal to 82 GPa, and a liquidus viscosity of the glass article is greater than or equal to 750 poise.

9. The glass article of claim 1, wherein a coefficient of thermal expansion of the glass article is greater than or equal to 45×10⁻⁷/° C. and less than or equal to 70×10⁻⁷/° C., a Young's modulus of the glass article is greater than or equal to 82 GPa, and a liquidus viscosity of the glass article is greater than or equal to 3000 poise.

10. A method comprising:
melting, in a melter, a first glass composition comprising a combination of glass constituent components in first relative proportions, the first relative proportions including a first constituent component at a first concentration;
feeding into the melter a second glass composition comprising the combination of glass constituent components in second relative proportions, the second relative proportions including the first constituent component at a second concentration, the second concentration differing from the first concentration;
forming at least three glass articles from a molten glass exiting the melter, the at least three glass articles comprising:
a first glass article having a composition comprising the first glass composition;
at least one intermediate glass article having a composition comprising the combination of glass constituent components in third relative proportions, the third relative proportions including the first constituent component at a third concentration, the third concentration differing from the first concentration and the second concentration; and
a final glass article having a composition different from the composition of the first glass article and the composition of the at least one intermediate glass article;
wherein the first glass composition and the second glass composition comprise:
greater than or equal to 60 mol % and less than or equal to 80 mol % SiO₂;
greater than or equal to 5 mol % and less than or equal to 25 mol % Al₂O₃;
greater than or equal to 0.25 mol % and less than or equal to 10 mol % MgO;
greater than or equal to 0.25 mol % and less than or equal to 10 mol % Na₂O;
greater than or equal to 0 mol % and less than or equal to 2 mol % Li₂O;
greater than or equal to 0 mol % and less than or equal to 9 mol % La₂O₃; and
greater than or equal to 0 mol % and less than or equal to 9 mol % T₂O₃,
wherein La₂O₃+Y₂O₃ is greater than or equal to 2 mol % and less than or equal to 9 mol %, and
wherein (La₂O₃+Y₂O₃)/(R₂O+RO) is greater than or equal to 0.1 and less than or equal to 2, R₂O being the sum of Na₂O, Li₂O, and K₂O and RO being the sum of MgO, CaO, SrO, and BaO.

11. The method of claim 10, wherein the final glass article comprises the second glass composition.

12. The method of claim 10, wherein the first concentration is different from the second concentration by no more than 2 mol %.

13. The method of claim 10, wherein the first glass article and the final glass article each comprise a coefficient of thermal expansion greater than or equal to 45×10⁻⁷° C. and less than or equal to 70×10⁻⁷° C., a Young's modulus greater than or equal to 82 GPa, and a liquidus viscosity greater than or equal to 750 poise.

14. The method of claim 10, wherein each of the at least three glass articles is in the form of a boule.

15. The method of claim 10, wherein each of the at least three glass articles is in the form of a sheet.

16. The method of claim 10, wherein the feeding the second glass composition is simultaneous with the forming the at least three glass articles.

17. A glass composition comprising:
greater than or equal to 60 mol % and less than or equal to 80 mol % SiO₂;
greater than or equal to 5 mol % and less than or equal to 25 mol % Al₂O₃;
greater than or equal to 0.25 mol % and less than or equal to 10 mol % MgO;
greater than or equal to 0.25 mol % and less than or equal to 10 mol % Na₂O;
greater than or equal to 0 mol % and less than or equal to 2 mol % Li₂O;
greater than or equal to 0 mol % and less than or equal to 9 mol % La₂O₃; and
greater than or equal to 0 mol % and less than or equal to 9 mol % T₂O₃,
wherein La₂O₃+Y₂O₃ is greater than or equal to 2 mol % and less than or equal to 9 mol %, and
wherein (La₂O₃+Y₂O₃)/(R₂O+RO) is greater than or equal to 0.1 and less than or equal to 2, R₂O being a sum of Na₂O, Li₂O, and K₂O expressed in mol %, and RO being a sum of MgO, CaO, SrO, and BaO expressed in mol %.

18. The glass composition of claim 17 comprising greater than or equal to 0.75 mol % and less than or equal to 8 mol % Na₂O.

19. The glass composition of claim 17, wherein La₂O₃+Y₂O₃ is greater than or equal to 3 mol % and less than or equal to 8 mol %.

20. The glass composition of claim 17, wherein (La₂O₃+Y₂O₃+R₂O+RO)/Al₂O₃ is greater than or equal to 0.5 and less than or equal to 2.5.
